(19) United States
(12) Patent Application Publication
(10) Pub. No.: US 2026/0369063 A1
(43) Pub. Date: Nov. 19, 2026

(54) SENSOR DATA PROCESSING SYSTEM AND METHOD

(71) Applicant: MoiiAI Inc., Troy, MI (US)

(72) Inventors: Deepak Upadyaya, Rochester Hills, MI (US); R L Naveenrajamaran, Chennai (IN); Lakshman Balasubramanian, Ingolstadt (DE)

(21) Appl. No.: 19/143,955

(22) PCT Filed: Dec. 22, 2023
(86) PCT No.: PCT/US2023/085722

§ 371 Date: Jun. 27, 2025

Related U.S. Application Data
(60) Provisional application No. 63/435,366, filed on Dec. 27, 2022.

(51) Int. Cl. G06V 20/52; G06T 7/246; G06T 7/73; G06V 10/82

(52) U.S. Cl. CPC G06V 20/52; G06T 7/251; G06T 7/75; G06V 10/82; G06T 2207/10016; G06T 2207/20084; G06T 2207/20092; G06T 2207/30232

(57) ABSTRACT

A system and method for processing image data and/or other sensor data, for various processing tasks, including: real-time processing of image sensor data using machine learning models within a web server client framework; feature vector extraction for entity' movement tracking; and occupancy information determination through an image processing framework having four processing pipelines (image extraction, asynchronous containerized inference, training, and analytics); automatic training data flagging, automatic training of neural networks (NNs) and/or other ML models; and asynchronous inference applications for real-time processing of image data for various custom tasks including handheld weapon detection, occupancy counts, and/or other information derived or inferred from the image data and/or other sensor data.

### TECHNICAL FIELD

This disclosure relates to methods and systems for processing sensor data and, more particularly and at least according to some embodiments, to methods and systems for processing image data streams.

### BACKGROUND

The field of real-time, asynchronous image and video processing from multiple camera feeds is one of continuous evolution. Traditional systems, hampered by their limitation to process single feed data and their struggle with varying camera attributes, are ripe for improvement. One such improvement is the introduction of a system capable of real-time, multi-feed processing. Machine learning, with a specific emphasis on convolutional neural networks (CNNs), plays a pivotal role in tasks such as object detection, image classification, and segmentation. However, these tasks present a significant challenge due to the substantial computational resources and large, labeled datasets required for training.

### SUMMARY

According to a first aspect, there is provided an image processing system. The image processing system includes at least one processor and memory accessible by the at least one processor, the memory storing computer instructions that, when executed by the at least one processor, cause the image processing system to: receive an image data stream having image data captured by at least one camera; identify spatial relationships between regions; generate a directed network graph representing the identified spatial relationships; and track movement of an entity between zones through use of the directed network graph.

According to embodiments, the image processing system according to the first aspect further includes one or more of the following features, including any technically-feasible combination of the following features:
the image processing system is configured to track movement of an entity between zones includes inspecting image data to determine whether the entity is in a particular zone;
zone configuration data is used to define the spatial relationships between the regions;
the zone configuration data is specified by a user through a graphical user interface (GUI);
the spatial relationships between the regions are learned by processing image data captured by a plurality of cameras having fields of views covering the regions;
the image processing system is configured to: obtain first image data and second image data, each of which represents an image depicting an individual; generate a first feature vector using the first image data and a second feature vector using the second image data; and determine whether the individual depicted in the first image data is the same individual depicted in the second image data through comparison of the first feature vector to the second feature vector;
the first feature vector and the second feature vector are generated using a machine learning (ML) technique, and wherein the ML technique is a neural network (NN);
the NN is a convolutional NN; and/or
the first feature vector is a deep feature vector that is generated through ML processing of the first image data using more than one NN layer.

According to a second aspect, there is provided an image processing system. The image processing system includes at least one processor and memory accessible by the at least one processor, the memory storing computer instructions that, when executed by the at least one processor, cause the image processing system to: receive an image data stream having image data captured by at least one camera; identify a processing server to be used to process the image stream using a machine learning (ML) model, wherein a web server client framework is used to allocate image stream processing of a plurality of image data streams including the image data stream to a plurality of processing servers whereby the processing server is identified among the plurality of processing servers to carry out the image stream processing for the image data stream; execute the ML model on the image data to obtain an inference output; and determine a real time activity based on the inference output.

According to a third aspect, there is provided an image processing system. The image processing system includes at least one processor and memory accessible by the at least one processor, the memory storing computer instructions that, when executed by the at least one processor, cause the image processing system to: receive a plurality of image data streams, wherein each image data stream of the plurality of image data streams has image data captured by at least one camera; for each of the plurality of image data streams, identify a processing server to be used to process the image data stream using a machine learning (ML) model, wherein a web server client framework is used to allocate image data stream processing of the plurality of image data streams to a plurality of servers whereby the processing server is identified among the plurality of servers to carry out the image data stream processing; for each of the plurality of image data streams, execute the ML model on the image data to obtain an inference output; and for each of the plurality of image data streams, determine a real time activity value based on the inference output.

According to a fourth aspect, there is provided a sensor data processing system. The sensor data processing system includes: an ingress server subsystem, a sensor data processing server subsystem, and a machine learning (ML) retraining subsystem. The ingress server subsystem has at least one processor and memory storing ingress server computer instructions. The at least one processor of the ingress server subsystem is configured to execute the ingress server computer instructions to carry out one or more ingress server subsystem operations. The one or more ingress server subsystem operations include: receive a plurality of sensor data feeds, wherein each sensor data feed of the plurality of sensor data feeds has sensor data captured by at least one sensor; for each of the plurality of sensor data feeds, identify a processing server of the plurality of sensor data processing servers to be used to process the sensor data feed, wherein a web server client framework is used to allocate sensor data feed processing of the plurality of sensor data feeds to the plurality of sensor data processing servers; and for each of the plurality of sensor data feeds, execute the ML model on the sensor data to obtain an inference output. The sensor data processing server subsystem has memory storing sensor data processing computer instructions and a plurality of sensor data processing servers each configured to execute the sensor data processing computer instructions. Each of the plurality of sensor data processing servers resides on one or more graphics processing units (GPUs) configured to execute the sensor data processing computer instructions to carry out one or more sensor data processing subsystem operations. The one or more sensor data processing subsystem operations include: executing an ML model to process the sensor data feed, including inputting the sensor data into the ML model and outputting an inference output. The machine learning (ML) retraining subsystem has at least one processor and memory storing ML retraining computer instructions. The at least one processor of the ML retraining system is configured to execute the ML retraining computer instructions to carry out one or more ML retraining subsystem operations. The one or more ML retraining subsystem operations include: monitoring for a trigger condition based on the inference output of the ML model; when the trigger condition is satisfied, identifying sensor retraining data based on the inference output of the ML for which the trigger condition was satisfied; retraining the ML model using the identified sensor retraining data; and redeploying the ML model to one or more of the plurality of sensor data processing servers.

According to a fifth aspect, there is provided an image processing system. The image processing system includes at least one processor and memory accessible by the at least one processor, the memory storing computer instructions that, when executed by the at least one processor, cause the image processing system to: receive an image data stream having image data captured by at least one camera; identify a server to be used to process the image feed using a machine learning (ML) model; execute the ML model on the image data to obtain an inference output; determine whether a real time activity trigger condition is satisfied by the inference output; and when it is determined that the real time activity trigger condition is satisfied by the inference output, obtain retraining image data to be used in retraining based on the image data that the ML model was executed on.

According to a sixth aspect, there is provided an image processing system. The image processing system includes at least one processor and memory accessible by the at least one processor, the memory storing computer instructions that, when executed by the at least one processor, cause the image processing system to: receive an image data stream having image data captured by at least one camera; identify a processing server to be used to process the image stream using a machine learning (ML) model, wherein a web server client framework is used to allocate image stream processing of a plurality of image data streams including the image data stream to a plurality of processing servers whereby the processing server is identified among the plurality of processing servers to carry out the image stream processing for the image data stream; execute the ML model on the image data to obtain an inference output; and determine a real time activity based on the inference output.

According to a seventh aspect, there is provided an image processing system. The image processing system includes at least one processor and memory accessible by the at least one processor, the memory storing computer instructions that, when executed by the at least one processor, cause the image processing system to: receive a plurality of image data streams, wherein each image data stream of the plurality of image data streams has image data captured by at least one camera; for each of the plurality of image data streams, identify a processing server to be used to process the image data stream using a machine learning (ML) model, wherein a web server client framework is used to allocate image data stream processing of the plurality of image data streams to a plurality of servers whereby the processing server is identified among the plurality of servers to carry out the image data stream processing; for each of the plurality of image data streams, execute the ML model on the image data to obtain an inference output; and for each of the plurality of image data streams, determine a real time activity value based on the inference output.

According to an eighth aspect, there is provided a sensor data processing system. The sensor data processing system includes: an ingress server subsystem, a sensor data processing server subsystem, and a machine learning (ML) retraining subsystem. The ingress server subsystem has at least one processor and memory storing ingress server computer instructions. The at least one processor of the ingress server subsystem is configured to execute the ingress server computer instructions to carry out one or more ingress server subsystem operations. The one or more ingress server subsystem operations include: receive a plurality of sensor data feeds, wherein each sensor data feed of the plurality of sensor data feeds has sensor data captured by at least one sensor; for each of the plurality of sensor data feeds, identify a processing server of the plurality of sensor data processing servers to be used to process the sensor data feed, wherein a web server client framework is used to allocate sensor data feed processing of the plurality of sensor data feeds to the plurality of sensor data processing servers; and for each of the plurality of sensor data feeds, execute the ML model on the sensor data to obtain an inference output. The sensor data processing server subsystem has memory storing sensor data processing computer instructions and a plurality of sensor data processing servers each configured to execute the sensor data processing computer instructions. Each of the plurality of sensor data processing servers resides on one or more graphics processing units (GPUs) configured to execute the sensor data processing computer instructions to carry out one or more sensor data processing subsystem operations. The one or more sensor data processing subsystem operations include: executing an ML model to process the sensor data feed, including inputting the sensor data into the ML model and outputting an inference output. The machine learning (ML) retraining subsystem has at least one processor and memory storing ML retraining computer instructions. The at least one processor of the ML retraining system is configured to execute the ML retraining computer instructions to carry out one or more ML retraining subsystem operations. The one or more ML retraining subsystem operations include: monitoring for a trigger condition based on the inference output of the ML model; when the trigger condition is satisfied, identifying sensor retraining data based on the inference output of the ML for which the trigger condition was satisfied; retraining the ML model using the identified sensor retraining data; and redeploying the ML model to one or more of the plurality of sensor data processing servers.

According to a ninth aspect, there is provided an image processing system. The image processing system includes at least one processor and memory accessible by the at least one processor, the memory storing computer instructions that, when executed by the at least one processor, cause the image processing system to: receive an image data stream having image data captured by at least one camera; identify a server to be used to process the image feed using a machine learning (ML) model; execute the ML model on the image data to obtain an inference output; determine whether a real time activity trigger condition is satisfied by the inference output; and when it is determined that the real time activity trigger condition is satisfied by the inference output, obtain retraining image data to be used in retraining based on the image data that the ML model was executed on.

According to a tenth aspect, there is provided an image processing system. The image processing system includes at least one processor and memory accessible by the at least one processor, the memory storing computer instructions that, when executed by the at least one processor, cause the image processing system to: receive an image data stream having image data captured by at least one camera; identify spatial relationships between regions; generate a directed network graph representing the identified spatial relationships; and track movement of an entity between zones through use of the directed network graph.

According to embodiments, the image processing system according to the tenth aspect further includes one or more of the following features, including any technically-feasible combination of the following features:
the image processing system is configured to track movement of an entity between zones includes inspecting image data to determine whether the entity is in a particular zone;
zone configuration data is used to define the spatial relationships between the regions;
the zone configuration data is specified by a user through a graphical user interface (GUI);
the spatial relationships between the regions are learned by processing image data captured by a plurality of cameras having fields of views covering the regions;
the image processing system is configured to: obtain first image data and second image data, each of which represents an image depicting an individual; generate a first feature vector using the first image data and a second feature vector using the second image data; and determine whether the individual depicted in the first image data is the same individual depicted in the second image data through comparison of the first feature vector to the second feature vector;
the first feature vector and the second feature vector are generated using a machine learning (ML) technique, and wherein the ML technique is a neural network (NN);
the NN is a convolutional NN; and/or
the first feature vector is a deep feature vector that is generated through ML processing of the first image data using more than one NN layer.

According to an eleventh aspect, there is provided a method of preparing image data for real-time asynchronous processing. The method includes: receiving formatted image data from a plurality of image data feeds, each image data feed of the plurality of image data feeds being comprised of formatted image data for a camera; and selectively providing the formatted image data to a plurality of asynchronous processing pipelines. The image data initially captured by the camera in a native format of the camera is formatted according to predefined image format. The predefined image format specifies one or more of the following: an image quality, an image size, an image resolution, and an image data format. Each asynchronous processing pipeline of the plurality of asynchronous processing pipelines is used to process the formatted image data of one or more image data feeds of the plurality of image data feeds.

According to embodiments, the method according to the tenth aspect further includes one or more of the following features, including any technically-feasible combination of the following features:
each of the plurality of image data feeds is transmitted from the camera using a real-time communication protocol, wherein the real-time communication protocol is real-time transport protocol (RTP), and wherein transmissions using RTP are augmented using real-time control protocol (RTCP);
the camera that captured a first image data feed of the plurality of image data feeds is a different make or model than the camera that captured a second image data feed of the plurality of image data feeds;
the predefined image format is defined by a two-dimensional resolution, wherein the two-dimensional resolution is specified by a pixel width and a pixel height, and wherein the pixel width is a number of pixels in a horizontal direction and the pixel height is a number of pixels in a vertical direction orthogonal to the horizontal direction;
camera provisioning data is obtained for the camera for each image data feed of the plurality of image data feeds, wherein the camera provisioning data is used to generate the formatted image data, and wherein the camera provisioning data for a first image data feed is different than the camera provisioning data for a second image data feed;
the formatted image data for each of the plurality of image data feeds is published as published image data to a publish-subscribe messaging subsystem, and wherein each asynchronous processing pipeline of the plurality of asynchronous processing pipelines is configured to selectively access the published image data based on subscription data for the asynchronous processing pipeline;
STOMP (Simple (or Streaming) Text Oriented Messaging Protocol) is used to publish the image data to the publish-subscribe messaging subsystem; and/or
an image extractor pipeline is executed at a camera local network in order to generate the formatted image data.

According to a twelfth aspect, there is provided a method of asynchronously performing convolution-based inference in real-time for a plurality of different image processing tasks. The method includes: obtaining image data captured by a camera through accessing a publish-subscribe messaging subsystem through subscribing to a topic associated with the image data; obtaining camera custom settings for the camera, wherein the custom camera settings include network graph data representing a network graph in which the camera and one or more other cameras co-located with the camera are situated in a manner defining spatial relationships (adjacencies) between the camera and the one or more other cameras; selecting an inference model for convolution-based inference processing of the image data; tracking an object within the image data using the network graph and the selected inference model; determining whether a trigger condition is satisfied for the image data based on the tracking of the object; and when the trigger condition is satisfied for the image data, storing output data that is based on an inference output generated by the selected inference model.

According to embodiments, the method according to the twelfth aspect further includes one or more of the following features, including any technically-feasible combination of the following features:
the output data is used to perform an image processing task on the image data;
the image processing task is counting persons in a given area;
the image processing task is detecting an object belonging to one or more predetermined classifications;
the one or more predetermined classifications is a handheld weapon; and/or
the one or more predetermined classifications includes a gun.

According to embodiments, the first through twelfth aspects each includes any combination of those features recited in connection with another aspect, to the extent such combination is technically-feasible, as appreciated in light of the description of the various embodiments presented herein.

### BRIEF DESCRIPTION OF THE DRAWINGS

Preferred exemplary embodiments will hereinafter be described in conjunction with the appended drawings, wherein like designations denote like elements, and wherein:

FIG. 1 is a diagrammatic illustration of a communications system that includes a plurality of image capture systems and a sensor data processing system, according to at least one embodiment;

FIG. 2 is a diagrammatic illustration of the sensor data processing system of FIG. 1, according to an embodiment in which the sensor data processing system is configured to use a web server client framework;

FIG. 3 is a diagrammatic illustration of the sensor data processing system of FIG. 1, according to an embodiment in which the sensor data processing system includes a multi-server sensor data processing computer implementing a web server client framework using user datagram protocol (UDP);

FIG. 4 is a flowchart of a method of executing a machine learning (ML) model on a sensor data stream to generate an inference output, according to an embodiment;

FIG. 5 is a flowchart of a method of determining a real time activity for each of a plurality of image data streams, according to an embodiment;

FIG. 6 is a flowchart of a method of retraining an ML model based on monitoring inference outputs, according to an embodiment;

FIGS. 7A-7D depict exemplary images of an image data stream in which a scene is depicted over time;

FIG. 8 is a flowchart of a sensor data feature extraction trigger process, including an example of feature vectors that are extracted from an image data stream and that are used as a part of a real time activity trigger, according to one embodiment;

FIG. 9 is a flowchart of a method of configuring an image processing system to track an entity's movement between zones, according to an embodiment;

FIG. 10 is a plan view of a floor of a building showing camera locations, camera coverage areas, and floor entrance and exit points;

FIG. 11 depicts a directed network graph generated for the floor of the building of FIG. 10;

FIG. 12 is a flowchart of a method of determining occupancy information for a region that includes occupiable portions (i.e., zones/areas that are occupiable by a human being) not within a field of view, or an occupancy determination process, according to one embodiment;

FIG. 13 is an example of an image frame of an image data stream where a first occupancy line boundary and a second occupancy line boundary are shown for the image frame;

FIGS. 14A-H depict a series of eight image frames of an image data stream in which an individual moves throughout a region within a field of view (FOV) of the image data stream;

FIG. 15 is a plan view of a floor of a building, including cameras located in different rooms, and where the building is divided into zones, including camera-FOV zones and camera dark zones;

FIG. 16 depicts a directed network graph generated for the floor of the building of FIG. 15;

FIG. 17 is a flowchart of a method of determining occupancy information for a region that includes occupiable portions, according to one embodiment;

FIG. 18 is a diagrammatic illustration of a sensor data processing system, namely an image processing system comprised of four processing pipelines: an image extraction pipeline, a plurality of asynchronous containerized inference pipelines, a training pipeline, and an analytics pipeline, according to one embodiment;

FIG. 19 is a flowchart of an image extraction process used for formatting image data for consumption by one or more asynchronous processing pipelines, according to one embodiment; and

FIG. 20 is a flowchart of a method of asynchronously processing image data in real-time, according to one embodiment.

### DETAILED DESCRIPTION

Video and/or image monitoring systems, including closed-circuit television (CCTV) systems, often capture a large quantity of image data, such as when continuous monitoring is performed and/or high resolution image capture devices are used. These image capture systems include processing image data from one or more cameras, where each camera is associated with an image data stream having image data captured by the camera. This image data may be processed using image processing techniques, such as for purposes of object recognition, entity/object tracking, occupancy counts, etc.

Entity tracking techniques may be employed to track an entity's movement based on using object recognition techniques on an image data stream.

Some image processing systems may employ machine learning (ML) techniques or models. Many conventional ML systems, such as those used for image processing, execute fixed ML models that need to be manually retrained, redeployed, and/or managed.

It has been recognized that conventional sensor data processing systems and, in particular, image data processing systems, generally employ a large amount of resources for sensor data processing, especially when the incoming data is large in size as is often the case when dealing with CCTV and other video monitoring systems as the resolution and capture rate of cameras nowadays is quite high. Image processing systems may not be suitably adapted for handling resource-intensive processing of large data sets while being scalable as the number and amount of data for processing may vary. This is particularly true for processing image data from CCTV systems as each CCTV (or other sensor capture) system may be configured differently, capture data with different sensing parameters, use different encodings, etc. Of course, this is also the case with regards to processing other types of sensor data, such as radar sensor data, force sensor data, etc.

Furthermore, with respect to image data stream processing, it has been recognized that conventional systems generally employ a large amount of resources for entity tracking as conventional methodologies for generating spatial mappings, representations, and/or reductions are not structured for enabling entity tracking anomaly detection. Additionally, real time querying speeds of spatial information stored as a part of such mappings or representations may be improved upon.

Still further, conventional ML systems, such as those used for image processing, execute fixed ML models that need to be manually retrained, redeployed, and/or managed. Moreover, conventional ML sensor data processing systems and, in particular, conventional ML image data processing systems are generally retrained using manually-selected training data that is initially or partly identified/selected by a technician or specialist.

According to embodiments, the disclosed systems and methods address the above-described problems.

The disclosed systems and methods described herein may be used to enable generating a processing output that is based on processing sensor data received from a sensor capture system; according to embodiments, the disclosed systems and methods are used to generate an inference output based on executing a machine learning (ML) model with image stream data having image data from an image sensor (e.g., camera) as input into the ML model. According to one embodiment, the inference output is used to determine an occupancy count that indicates a number of individuals (or persons) determined or estimated to be present. It should be appreciated that this is but one embodiment as the systems and methods may be applied to other sensor data streams having various types of sensor data, such as radar sensor data, lidar sensor data, auditory sensor data, etc.

According to embodiments, a sensor data processing system is provided, where the sensor data processing system includes at least one processor and memory accessible by the at least one processor, the memory storing computer instructions that, when executed by the at least one processor, cause the image processing system to carry out one or more sensor data processing operations. According to one embodiment, the one or more sensor data processing operations include: receiving an image data stream having image data captured by at least one camera; identifying a processing server to be used to process the image data stream using a machine learning (ML) model, wherein a web server client framework is used to allocate image data stream processing of a plurality of image streams including the image data stream to a plurality of servers whereby the processing server is identified among the plurality of servers to carry out the image data stream processing; executing the ML model on the image data to obtain an inference output; and determining a real time activity value based on the inference output.

According to some embodiments, the one or more sensor data processing operations include: executing the ML model on the image data to obtain an inference output; determining whether a real time activity trigger condition is satisfied by the inference output; and when it is determined that the real time activity trigger condition is satisfied by the inference output, obtaining retraining image data to be used in retraining based on the image data that the ML model was executed on.

According to embodiments, there is provided a method for tracking an entity's movement between zones, where the method includes the steps of: receiving an image data stream having image data captured by at least one camera; identifying spatial relationships between regions; generating a directed network graph representing the identified spatial relationships; and tracking movement of an entity between zones through use of the directed network graph. In embodiments, movement of an entity between zones is tracked by inspecting image data to determine whether the entity is in a particular zone based on generated feature vectors, which may be generated using a convolutional neural network (CNN) or other ML technique, for example. In embodiments, the feature vectors, which may be generated from two sets of image data, are compared first image data and second image data, each of which represents an image depicting an individual. Then, according to embodiments, it is determined whether an individual depicted in the first image data is the same individual depicted in the second image data through comparison of the first feature vector to the second feature vector.

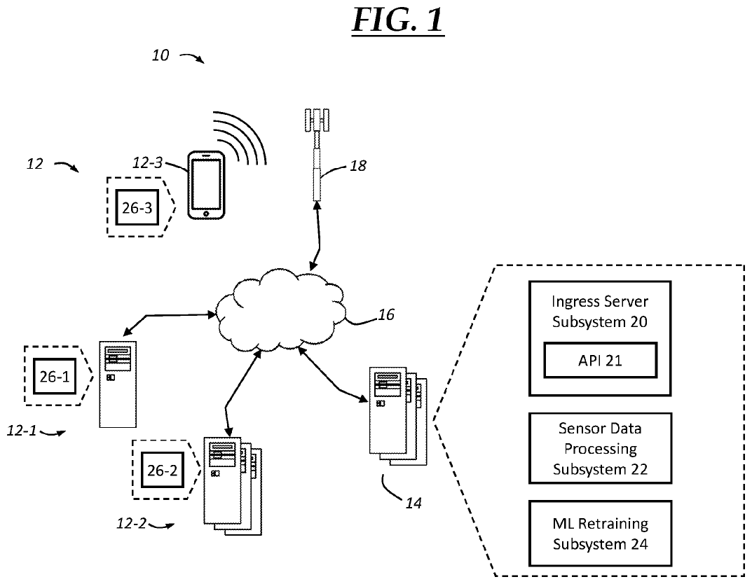

With reference now to FIG. 1, there is shown a communications system 10 having a plurality of sensor capture systems 12, a sensor data processing system 14, a land network 16, and a wireless communications system 18. The sensor data processing system 14 includes an ingress server subsystem 20 having an application programming interface (API) 21, a sensor data processing subsystem 22, and a machine learning (ML) retraining subsystem 24. According to at least some embodiments, the communications system 10 may include a cloud-based sensor data processing system as the system 14, which may include one or more subsystems 20-24 and which may carry out one or more steps of one or more methods disclosed herein. It should be appreciated that the embodiment of FIG. 1 is but one example of a communications system that may be used and one example of a sensor data processing system that may be used; accordingly, it should be appreciated that the number, arrangement, and configuration of the components of the communications system and the sensor data processing system may vary and/or depend on the application in which the sensor data processing system is used and/or the environment in which the sensor data processing system is implemented. In the present embodiment, the sensor data processing system is described as an image processing system that is used to process image data, such as picture and/or video data. However, it should be appreciated that the disclosed system and method may be applied to a variety of sensor capture systems, such as audio sensor systems or radar sensor sensors, for example.

Each of the plurality of sensor capture systems 12-1,12-2,12-3 (three shown in FIG. 1) includes at least one sensor 26-1,26-2,26-3 that captures sensor data and, in the present exemplary embodiment, is an image sensor that captures image data, such as a digital camera that captures two-dimensional images. The sensor capture systems 12-1,12-2,12-3 are each shown as being connected to the land network 16 and/or the wireless carrier system 18; however, it should be appreciated that any suitable means for communication between the sensor capture systems 12-1,12-2,12-3 and the sensor data processing system 14 may be used. In one embodiment, the at least one sensor 26-1,26-2,26-3 is a camera or other image sensor that obtains image data. In some embodiments, the image sensor may be positioned so that its field of view faces a region occupiable by persons, such as regions inside office buildings, stores, etc. Various types of sensors and sensor configurations may be used by the sensor capture systems, and the sensor capture systems may use different sensors and/or configurations. In some embodiments, one or more of the sensor capture systems 12-1,12-2,12-3 includes a plurality of sensors as the at least one sensor 26-1,26-2,26-3. In some embodiments, one or more of the sensor capture systems 12-1,12-2,12-3 may be or employ a computer system that is connected to the internet (or other interconnected computer network system). In such embodiments, one or more of the sensor capture systems 12-1,12-2,12-3 may provide an application programming interface (API) that is usable to retrieve sensor data from the sensor capture system(s) 12-1,12-2,12-3. According to embodiments, one or more, such as all, of the sensor capture systems 12-1,12-2,12-3 may communicate with the sensor data processing system 14 through use of the API 21 of the ingress server subsystem 20, which is discussed more below.

The sensor data processing system 14 is a computer system that may include a network of computers and associated hardware (including memory), which may be co-located or distributed such as when implementing the system 14 on a cloud architecture. Generally, the sensor data processing system 14 is used to receive sensor data and process the sensor data to obtain an informative output, such as an inference output indicating occupancy counts based on processing image data, for example. The sensor data processing system 14 is described as including the ingress server subsystem 20, the sensor data processing subsystem 22, and the ML retraining subsystem 24; however, it should be appreciated that, according to embodiments, the sensor data processing system 14 may omit one or more of these subsystems and/or include one or more other subsystems. In embodiments, the sensor data processing subsystem 22 includes a plurality of processors, each of which is used to process one or more streams of sensor data. In some embodiments, each of the plurality of processors is used to process a plurality of sensor data streams; in such embodiments, the ingress server subsystem 20 may assign sensor data to a process of the sensor data processing subsystem 22 for processing.

The ingress server subsystem 20 includes at least one processor and memory having computer instructions, which may be referred to as ingress server computer instructions. The ingress server computer instructions may be executed by the at least one processor of the ingress server subsystem 20 and, when executed, cause the subsystem 20 to carry out ingress server subsystem operations. In general, the ingress server subsystem 20 is configured to receive sensor data that is captured by the at least one sensor 26-1,26-2,26-3 of the plurality of sensor capture systems 12-1,12-2,12-3. In one embodiment, the at least one sensor 26-1,26-2,26-3 is an image sensor that captures image data and the image data is then transmitted to the sensor data processing system 14. In some embodiments, the image data is a stream of image data (an “image data stream”) and is received continuously at the ingress server subsystem 20. In embodiments, the ingress server subsystem 20 is used to determine or select which server is to be used to process the received image data stream (or other sensor data) and to cause the selected server to process the image data stream. In some embodiments, the ingress server subsystem 20 may select a server for a particular sensor device or image data stream, or may select a server for a predetermined set of data, such as a 2 GB chunk of image data from one or more cameras. In some embodiments, a server is selected to process an image data stream that is being continuously received. In other embodiments, the ingress server subsystem 20 selects a server to process image or sensor data that is stored in a database and that is not being continuously streamed live from a sensor or sensor capture system.

In one embodiment, the ingress server subsystem operations include: receive a plurality of sensor data streams, wherein each sensor data stream of the plurality of sensor data streams has sensor data captured by at least one sensor; for each of the plurality of sensor data streams, identify a processing server of the plurality of sensor data processing servers to be used to process the sensor data stream, wherein a web server client framework is used to allocate sensor data stream processing of the plurality of sensor data streams to the plurality of sensor data processing servers; and for each of the plurality of sensor data streams, execute the ML model on the sensor data to obtain an inference output. The web server client framework is utilized by the ingress server subsystem 20 to select and/or allocate server resources of the server data processing subsystem 22 for processing sensor data. In particular, the ingress server subsystem 20 may use a WebSocket framework to allocate image data stream processing of a plurality of image or sensor data streams to a plurality of servers whereby the processing server is identified among the plurality of servers to carry out the image data stream processing.

In some embodiments, including in the depicted embodiment of FIG. 1, the ingress server subsystem 20 includes the API 21, which may be used for interfacing with one or more of the sensor capture systems 12. According to embodiments, one or more, such as all, of the sensor capture systems 12-1,12-2,12-3 may communicate with the sensor data processing system 14 through use of the API 21 of the ingress server subsystem 20; according to some of such embodiments, the sensor capture system(s) 12-1,12-2,12-3 may be configured to transmit image data streams using the API 21 and/or to provision a new sensor capture device (or sensor capture system) for use with the sensor data processing system 14. In this way, users of various sensor capture systems may readily and easily integrate their sensor capture systems with the services of the sensor data processing system 14 and, according to some embodiments, without manual intervention or with limited manual intervention. In embodiments, the API 21 is a software interface that enables software of a capture sensor system to communicate with software of the sensor data processing system 14 and, in particular in the present depicted embodiment, with the ingress server subsystem 20 of the sensor data processing system 14. In embodiments, the API 21 is configured according to an API specification that includes an API definition that sets forth or defines standards (e.g., formats, encodings), endpoint location(s), endpoint header information, and/or other parameters used for defining a standardized communication interface for communication of information from the sensor data capture systems 12 to the sensor data processing system 14. It should be appreciated that, according to some embodiments, the API 21 may be omitted and other means of communications between the sensor data capture systems 12 and the ingress server subsystem 20 (or other portion of the sensor data processing system 14) may be used.

The sensor data processing subsystem 22 includes at least one processor and memory having computer instructions, which may be referred to as sensor data processing computer instructions. In at least some embodiments, the sensor data processing subsystem 22 includes a plurality of processors, each of which is used to process sensor data in response to the ingress server subsystem 20 selecting a processor (and/or a portion or partition of the processor) for processing. In some embodiments, the sensor data processing subsystem 22 includes a plurality of graphical processing units (GPUs). The sensor data processing subsystem 22 includes a plurality of servers that are executed on the one or more processors (e.g., GPUs) of the sensor data processing subsystem 22. In some embodiments, each GPU may be used to implement one or more servers or “processing servers” and, in at least some embodiments, each GPU may be used to implement a plurality of servers. The number of servers per processor may be fixed or dynamically selected. The sensor data processing computer instructions may be executed by the at least one processor of the sensor data processing subsystem 22 and, when executed, cause the subsystem 22 to carry out sensor data processing subsystem operations. In one embodiment, the sensor data processing subsystem operations include: executing an ML model to process the sensor data stream, including inputting the sensor data into the ML model and outputting an inference output.

The ML retraining subsystem 24 includes at least one processor and memory having computer instructions, which may be referred to as ML retraining computer instructions. The ML retraining computer instructions may be executed by the at least one processor of the ML retraining subsystem 24 and, when executed, cause the subsystem 24 to carry out ML retraining subsystem operations. In one embodiment, the ML retraining subsystem operations include: monitoring for a trigger condition based on the inference output of the ML model; when the trigger condition is satisfied, identifying sensor retraining data based on the inference output of the ML model for which the trigger condition was satisfied; retraining the ML model using the identified sensor retraining data; and redeploying the ML model to one or more of the plurality of sensor data processing servers.

In one embodiment, each of (or at least one or more of) the ingress server subsystem 20, the sensor data processing subsystem 22, and the ML retraining subsystem 24 are separate subsystems that use different computers to execute their respective operations. In other embodiments, however, each of (or at least one or more of) the ingress server subsystem 20, the sensor data processing subsystem 22, and the ML retraining subsystem 24 may share or use common computers or other hardware to execute their respective operations.

Each of the plurality of sensor capture systems 12-1,12-2,12-3 is connected via the land network 16 and/or the wireless carrier system 18 to the sensor data processing system 14. The land communications network (or “land network” for short) may be a conventional data communications network that provides connectivity to between remote devices, and that can be used to connect the wireless carrier system to one or more networks or devices that are remote to one another, such as the plurality of sensor capture systems 12-1,12-2,12-3 and sensor data processing system 14. In one embodiment, the land network 16 includes a packet-switched data communications network that is used to provide access to Internet infrastructure. One or more segments of the land network 16 may be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 18 may include one or more cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components required to connect wireless carrier system with a land communications network or to connect the wireless carrier system with user equipment (UE), which could include certain devices of the sensor capture systems 12-1,12-2,12-3 and/or the sensor data processing system 14. The wireless carrier system may implement any suitable communications technology, including for example GSM/GPRS technology, CDMA or CDMA2000 technology, LTE technology, etc. In general, the wireless carrier system, its components, the arrangement of tis components, the interaction between the components, etc. is generally known in the art.

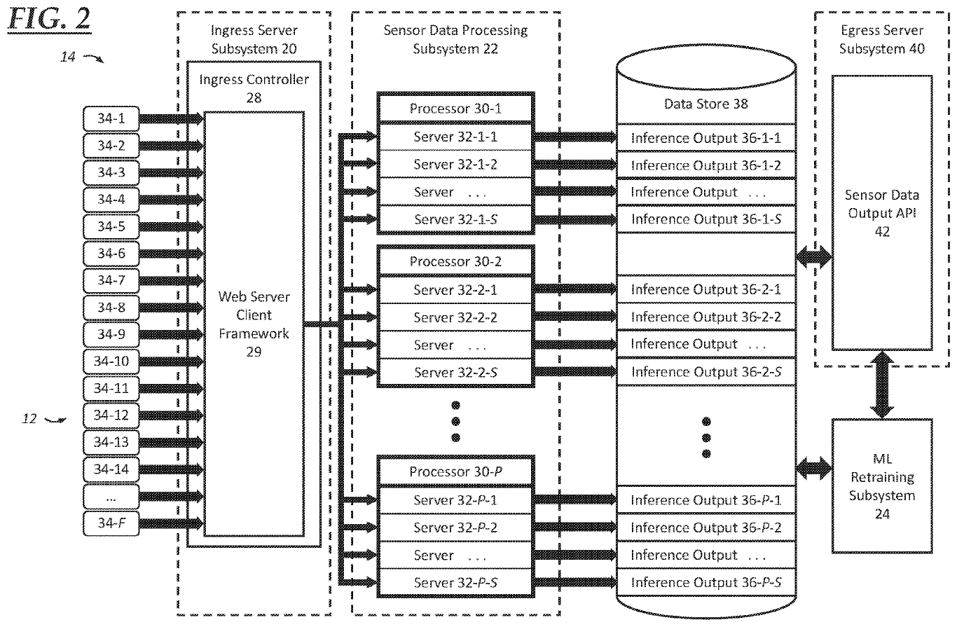

With reference to FIG. 2, there is shown the sensor data processing system 14, including the ingress server subsystem 20, the sensor data processing subsystem 22, and the ML retraining subsystem 24; in the embodiment of FIG. 2, the sensor data processing system 14 further includes a data store 38 and an egress server subsystem 40. It should be appreciated that, although FIGS. 1 and 2 depict embodiments of the sensor data processing system 14 as having certain components, according to other embodiments the sensor data processing system 14 may omit certain components (such as the API 21, the ML retraining system 24, the web server client framework 29, the data store 38, the egress server subsystem 40, and/or the sensor data output API 42) and/or include certain components. The ingress server subsystem 20 includes an ingress controller 28 that is configured to allocate sensor data streams to processing servers 32 being executed by one or more processors 30 of the sensor data processing subsystem 22. In the depicted embodiment, each processor of the plurality of processors 30 (where P equals the number of processors 30) is executing a fixed number S of servers. Thus, when P processors are being used, the subsystem 22 may execute up to P×S servers. Each of the S servers corresponds to a software container or flow that processes a stream of data, such as image processing that is performed on image data, and is used to produce an output, such as an inference output 36-p-s (where p is an index of the processor between 1 and P; and where s is an index of the processing server between 1 and S), which may be stored in a data store 38 of the sensor data processing system 14. In some embodiments, the ingress controller 28 is configured to assign each incoming sensor data stream or set of sensor data to be processed to a processing server 32 that will process the sensor data stream. The ingress controller 28 may thus balance processing based on monitoring processing of the plurality of processing servers 32 and by terminating servers 32 and/or by starting new servers 32, which may include starting new processors 30 to execute a new processing server or set of processing servers.

In some embodiments, the ingress controller 28 is configured to have a fixed or predetermined number of processing servers per processor, such as seven (7) processing servers per GPU (i.e., S=7 in this exemplary embodiment) when processing image data, for example. The number of GPUs 30 used may thus depend on the overall data processing bandwidth that is desired, which may be informed by the requirements of the process or application in which the system 14 is used. In at least one embodiment, the number of servers S per processor is fixed and the number of processors P is dynamically set by the ingress controller based on processing demand of the incoming sensor data streams 34. That is, according to some embodiments, the number P of processors used is dynamic and set by the ingress controller 28 in response to incoming sensor data streams that are to be processed, which is discussed more below. It should be noted that, according to embodiments, even though each processor may be determined or considered to have capabilities to execute S number of servers, each processor may not always be actively executing or running S processing servers. For example, when a new processor is started, not all server “slots” may be used initially or at least until such processing servers are needed and assigned by the ingress controller 28. Nonetheless, according to embodiments, each of the P processors is treated the same by the ingress controller 28 and is considered to have capabilities to support S processing servers for processing sensor data streams 34.

In embodiments, the ingress controller 28 is used to select a server to use for processing a sensor data stream. According to some embodiments, the ingress controller 28 is configured to continuously process incoming sensor data streams to determine, for each sensor data stream, a server to use for processing the sensor data stream. In embodiments, the ingress controller 28 may control one or more aspects of the sensor data processing subsystem 22, such as the servers 30. For example, in some embodiments, the ingress controller 28 is configured to start servers and/or terminate servers as needed depending on, for example, the number and/or size of incoming sensor data streams.

In the depicted embodiment of FIG. 2, an example of operating the sensor data processing system 14 is shown in which a plurality of image data streams are processed and where each of the plurality of image data streams or feeds 34-1, 34-2, . . . 34-F has image data captured by a camera 26-1, 26-2, . . . , 26-F where F is the total number of image data streams and also cameras in the depicted exemplary embodiment of FIG. 2. It should be appreciated that, even though FIG. 1 depicts three sensor capture systems 12-1,12-2,12-3 each having at least one sensor 26-1,26-2,26-3, any desired or suitable number of sensors may be used. Each of the cameras (or sensors) 26-1 through 26-F had been registered with the sensor data processing system 14 and configuration data is stored for each of the cameras (or sensors) 26-1 through 26-F at the sensor data processing system 14 (or in a manner so that the configuration data is accessible by the sensor data processing system 14). The configuration data for each camera or sensor 26 may specify information about sensor capture, such as frames per second, image/pixel resolution, color information such as color space used, metadata such as location and model of camera, zone configuration information, other spatial information, etc. The zone configuration information includes information regarding zones at a location at which the at least one sensor 26-1,26-2,26-3 is located at. This information may include directed network graph data, which is information representing a directed network graph, such as the directed network graph 1100 (FIG. 11) or the directed network graph 1600 (FIG. 16). In some embodiments, the configuration data may be used to determine a processing load for the camera/sensor, which may be based on an estimated or anticipated amount of processing needed—for example, the frame rates (e.g., frames per second (fps)) and image resolution may be used to determine the processing load. The processing load may then be used by the ingress controller 28 (or the ingress server subsystem 20) to determine and/or allocate server(s) for processing of the image data. This configuration data (or sensor configuration data) may be stored in any suitable data structure or warehouse, such as Firestore™, DynamoDB™, a SQL database, etc.

The ingress server subsystem 20 selects and allocates a processing server to each incoming server data stream, such as for each of the image data streams 34-1 . . . 34-F, using a processing server selection process—these image data streams are referred to generally as 34-f. In some embodiments, the ingress server subsystem 20 may exercise control over aspects of the sensor data processing subsystem 22; in some of such embodiments, for example, the ingress server subsystem 20 allocates processing servers for the incoming sensor data streams, which may include starting new processing servers—in some instances, starting new processing servers may entail acquiring one or more processors; for example, a new GPU may be started with a fixed number of processing servers executed thereon. In the depicted embodiment of FIG. 2, the ingress controller includes the web server client framework 29 that is used for selecting a processing server to the incoming server data streams or streams 34-f.

Each of the processing servers 32 are executing a machine learning (ML) model that is used to process the senor data so as to produce an inference output 36-p-s. The particular ML model used may be determined based on the type of sensor data, the desired nature of the inference output 36-p-s, and other factors. However, the inference output 36-p-s is based on the sensor data and, for example, may provide useful information, such as the number of occupants in a given area or building, for example. The processing servers 32 each produce an inference output 36-p-s, which may then be stored in the data store 38.

The data store 38 may be any suitable data storage device, platform, or system including, for example, a cloud database, such as Firestore™, DynamoDB™, SQL database, etc. The data store 38 may be referred to as a sensor data output data store 38, and this data may be accessible via an application programming interface (API) 42 provided by the system 14, which may be provided as a part of an egress server subsystem 40. The egress server subsystem 40 may be implemented by one or more processors and memory having egress server computer instructions that, when executed, cause egress server subsystem operations to be carried out. The egress server subsystem operations may include executing instructions to host or provide the sensor data output API 42, which is a computerized interface for accessing sensor data outputs, such as the inference outputs 36-p-s, that are produced by the processing servers of the sensor data processing subsystem 22. The discussion of the API 21 is hereby attributed to the API 42 to the extent such discussion is not inconsistent with the express description of the API 42.

The ML retraining subsystem 24 may be implemented using one or more processors and is used to retrain the ML model used by the processing servers 32. The ML retraining subsystem 24 is shown as being communicatively coupled to the data store 38 and the sensor data output API 42 of the egress server subsystem 40; it should be appreciated that, according to various embodiments, the ML retraining subsystem 24 may obtain data from the data store 38 (including the inference outputs 36-p-s) using a variety of transmission and communication paths.

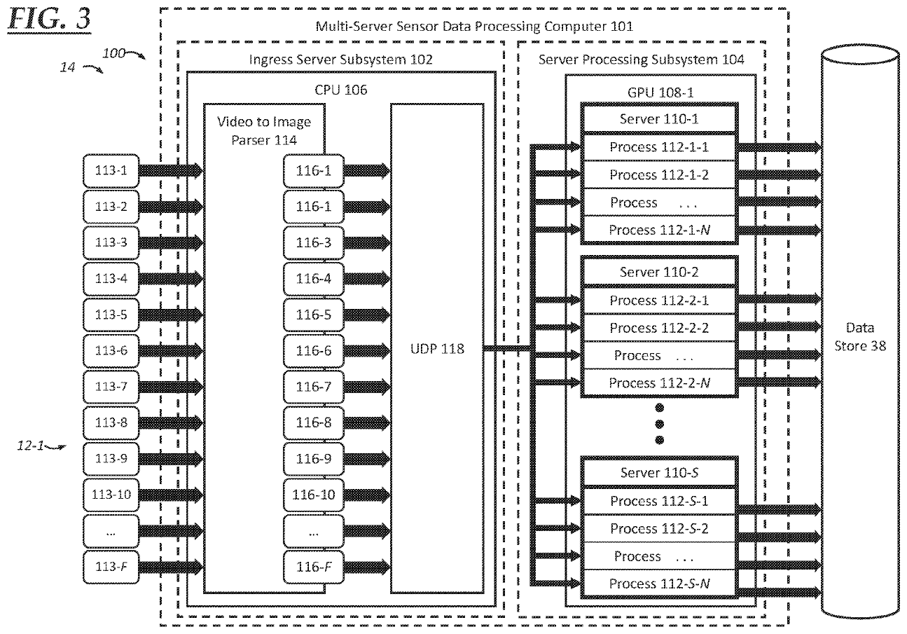

With reference to FIG. 3, there is shown an embodiment of a sensor data processing system 100 that may be used as the sensor data processing system 14 of FIG. 1, according to embodiments. It should be appreciated that, although FIG. 3 depicts an embodiment of the sensor data processing system 14 as having certain components, according to other embodiments the sensor data processing system 14 may omit certain components and/or include certain components, as will be appreciated in light of the following discussion.

The sensor data processing system 100 includes an ingress server subsystem 102 and a sensor data processing subsystem 104 that are implemented as a single computer 101, which may also be referred to as a multi-server sensor data processing computer 101. The multi-server sensor data processing computer 101 has a central processing unit (CPU) 106 and one or more graphics processing units (GPUs) 108-p, each executing one or more processing servers 110-s. In the depicted embodiment of FIG. 3, the one or more GPUs 108-p is the one GPU 108-1 since in this depicted embodiment P=1; however, it should be appreciated that any suitable number P of GPUs may be used. In general, components of FIGS. 1-2 correspond to like components of FIG. 3, such as the ingress server subsystem 20 corresponding to the ingress server subsystem 102, the server processing subsystem 22 corresponding to the server processing subsystem 104, etc.

Each of the processing servers 110-s executes one or more sensor data processing processes 112-s-n, where n is an index of the sensor data processing processes between 1 and N, and where N is the number of sensor data processing processes. The CPU 106, which corresponds to the ingress controller 28, executes a server determination process that is used to select a server for incoming image data streams 113-f. The incoming image data streams 113-f, which correspond to sensor data streams 34-f, are parsed using a video to image parser 114 into a plurality or set of images 116-f and these images 116-f are then assigned to a processing server 110-s by the CPU 106 using user datagram protocol (UDP) 118, which may be used as the web server client framework. According to embodiments, the CPU 106 assigns a source port and a destination port to each image data stream (or portion thereof) as a part of using UDP. In such embodiments, the source port may correspond to a port used by a process being executed by the CPU 106, and the destination port may correspond to a port of one of the processing servers 110-s. According to embodiments, UDP implementations like the one shown and described above, may be used to provide for fast transfers of incoming data streams, such as incoming image data streams or streams, while still being able to maintain processing order of images within the same stream, which means that, for a given data stream or stream, the images of the given data stream are processed in order of time so that images of the given data stream are not processed using the processing server(s) prior to processing images captured at a later time using the processing server(s). In some embodiments, the image data is transferred using a WebSocket opened at the GPU 108-1 using UDP and, in embodiments, the WebSockets may be dynamically opened, closed, and managed by the CPU 106 or the ingress controller 28.

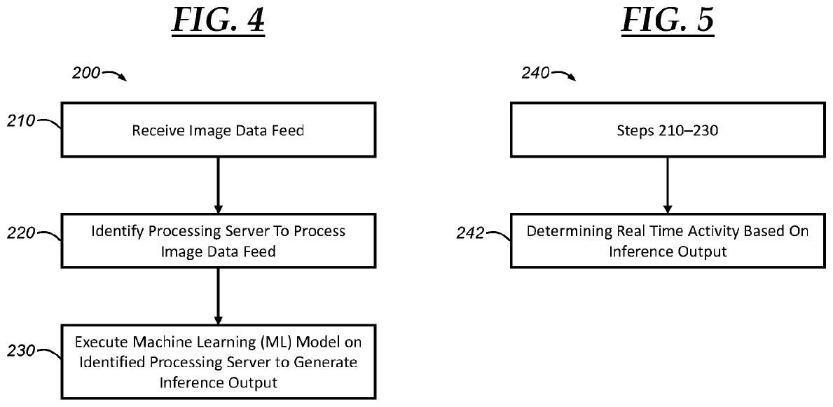

With reference to FIG. 4, there is shown a method 200 of executing a machine learning (ML) model on a sensor data stream to generate an inference output. The method 200 is carried out by the sensor data processing system 14, which may include using one or more processors thereof. According to embodiments, the method 200 represents steps performed for as a part of an iteration of a real time activity inference process 240, which is discussed more below. The method 200 is described with respect to an embodiment in which an image data stream (constituting the sensor data stream) is processed to generate an inference output; however, it should be appreciated that the method 200 may be used for processing a variety of other types of sensor data. The method 200 is described below with respect to processing an image data stream; however, it should be appreciated that the method 200 may be performed once each for each of a plurality of image data (or other sensor data) streams. In some embodiments, multiple executions of steps 210-240 may be performed simultaneously. In such embodiments, synchronization and atomic resource sharing techniques may be used for steps that refer to or use similar or like components of the sensor data processing system 14, such as the ingress controller 28 and/or the plurality of processors 30-p, for example.

The method 200 begins with step 210, wherein an image data stream having image data captured by at least one camera is received. As used herein, a camera includes any image sensor capable of capturing images represented by image data. The image data stream refers to a stream of image data for a particular camera and this image data stream may be a live image data stream or a live stream of image data from the camera. In at least some embodiments, the image data stream is received from the sensor capture system through a hot electronic data connection. As used herein, a “hot electronic data connection” is an electronic data connection, such as one over the internet, in which the data being transmitted over to a recipient device is not stored in a data store (excluding transitory storage of the data being transmitted) until after being received at the recipient device. It should be appreciated that, at least in some embodiments, the data being transmitted over a hot electronic data connection may be stored in a data store, such as a database or data lake, after having been (or simultaneously while being) received at the recipient device, which may be the ingress controller 28 in embodiments. The method 200 continues to step 220.

In step 220, a processing server, which is to be used to process the image data stream using a machine learning (ML) model, is identified. According to at least some embodiments, this step includes using a web server client framework to select a server to be used for image stream processing of the image data stream. In such embodiments, the web server client framework is used to allocate image stream processing of a plurality of image data streams including the image data stream to a plurality of processing servers whereby the processing server is identified among the plurality of processing servers to carry out the image stream processing for the image data stream.

The ML model uses an ML algorithm that is built on training data and is used to determine an inference output indicative of real time activity. In at least one embodiment, the ML model is an artificial neural network that includes an input layer, at least one hidden layer, and an output layer that provides the inference output. In some embodiments, the ML model is a deep neural network having a plurality of hidden layers. The ML model is trained using training data so as to determine proper weights and/or other parameters. The ML model may be trained using a variety of techniques, including unsupervised and supervised training techniques, suitable for the implementation in which it is to be used. According to one embodiment, the neural network is a feed forward neural network and, in particular, a deep feed forward (DFF) neural network. In at least some embodiments, a cached neural network is used; a cached neural network is a neural network with a feedback mechanism in which a portion of a first input is used at least partly for processing a subsequent input, and such cached neural networks may be implemented as or using a recurrent neural network (RNN), one or more gated recurrent units (GRUs), and/or one or more long short-term memory (LSTM) units. In at least one embodiment, a time-cached neural network is used for processing a time-series input data stream, which is a data stream having time series (or time-serialized) data associated with the substantive data, for example, the sensor readings. A time-cached neural network is a cached neural network in which time information associated with the data being processed is at least partly maintained for use in processing a next input of the time-series input data stream.

In one embodiment, time-serialized image data of the image data stream is input into the ML model, which then generates the inference output. In embodiments, the image data includes images associated with a time indicator that indicates a capture time of the image. In such embodiments, the ML model may be a time-cached neural network. In other embodiments, other types of ML models may be used. In embodiments where image recognition is employed, such as for purposes of occupancy counts and/or real time activity identifications, a convolutional neural network may be used. And, in at least one embodiment, a combination of different ML models or techniques may be employed to generate the ML model. For example, a convolution neural network may be used in conjunction with a time-cached neural network (having, for example, GRU(s), for example), and together these components constitute the ML model. The method 200 continues to step 230.

In step 230, the inference output is generated by executing the ML model on the image data stream. In this step, image data from the image data stream is inputted into the ML model to generate the inference output. In embodiments, the ML model uses a neural network having an input layer at which the image data is received. The image data of the image data stream may be processed prior to being input into the ML model—that is, modified image data that is processed for purposes of, for example, encoding and/or color space mappings, may be used as input into the ML model, which is considered as falling under the scope of executing the ML model on the image data stream. The inference output is generated by executing the ML model using the image data as input. In embodiments, the inference output indicates an occupancy count of a building or region. In other embodiments, the inference output indicates a real time activity. The inference output may be represented in many different forms, such as a stochastic probability curve, which may be sampled from or a set of discrete or real numerical values, as a couple examples.

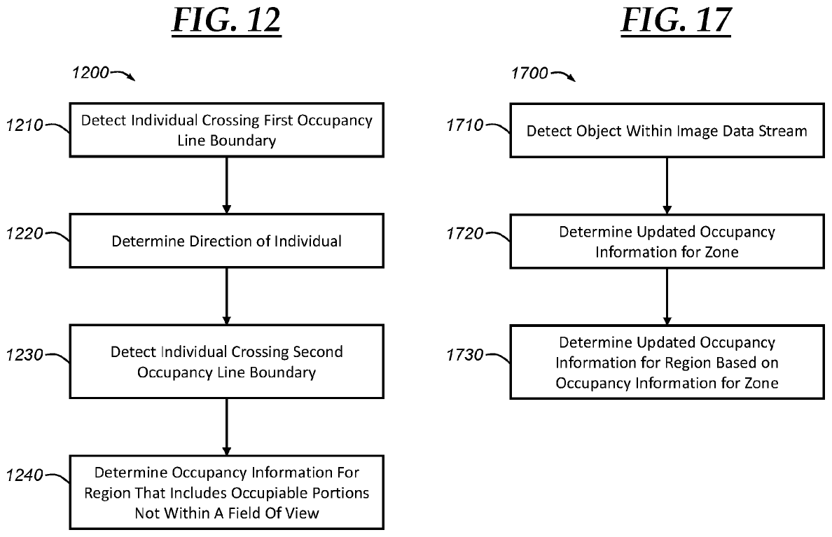

After the inference output is generated. The method 200 then ends. It should be appreciated that, in embodiments, the steps 210-230 may be performed for each of a plurality of image data streams to generate a plurality of inference outputs. In embodiments, the step 230 may be used to determine occupancy information for a room or other region that is contained (at least partly) within a field of view of one or more image capture devices or cameras. An occupancy determination process 1200 (FIG. 12) is discussed below and may be used for image processing in step 230, at least according to embodiments.

With reference to FIG. 5, there is shown a method 240 of determining a real time activity for each of a plurality of image data streams is performed. In embodiments, the method 240 includes one or more steps of the method 200, such as each of steps 210-230, for example, as illustrated in FIG. 5. The method 240 includes a step 242 of determining a real time activity based on the inference output generated in step 230. In step 242, the inference output is inspected and a real time activity descriptive of an event indicated by the image data stream is determined. A real time activity refers to an activity or event that is being performed or carried out, and may include human activity recognition (HAR) techniques (e.g., recognizing a particular body exercise, identifying an activity class (e.g., eating, reading, sleeping, walking)). The real time activity may indicate a presence of an individual, an action of an individual, occupancy counts of a building or other region, an action of a non-living object, presence of a non-living object, etc. The inference data is generated by the ML model, which is configured to generate an inference output indicative of the real time activity (or real time activities) shown or suggested within the image data of the image data stream. The real time activity (or real time activity value(s)), the inference output, and/or other related data may be stored in the data store 38, and/or may be transmitted to one or more local and/or remote computers. The real time activity may be represented by one or more real time activity values, which is any data represented in electronic or computer-readable format that indicates the real time activity or information about the real time activity. The one or more real time activity values may be the inference output or based on the inference output, at least in embodiments. The method 240 then ends.

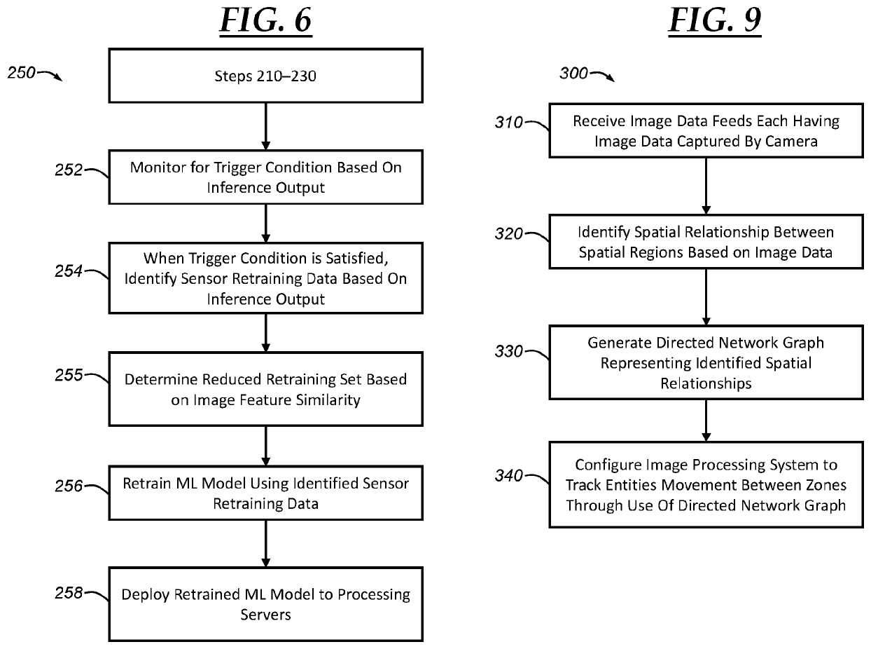

With reference to FIG. 6, there is shown a method 250 of retraining the ML model based on monitoring inference outputs. The method 200 may be used to generate a plurality of inference outputs. In embodiments, the method 250 includes one or more steps of the method 200, such as each of steps 210-230, for example; in some embodiments, the method 250 includes the step 242 as well, which may be performed as a part of preparing data for use in the monitoring performed in method 250, as discussed below. The method 250 includes a step 252 of monitoring for a trigger condition based on the inference output is performed. Here, the trigger condition may be, for example, when the inference output or a real time activity (which is based on the inference output) value exceeds one or more threshold values and/or when a particular classification/discrete value (or some other predefined condition) is present, for example. In one embodiment, the trigger condition is a real time activity trigger condition, and the inference output, which may be based on the image processing described above, for example, is used to determine whether the trigger condition is satisfied.

In some embodiments, the inference output is used to identify and classify objects within the image data feed. In such embodiments, the inference output is used to provide image classification in which a label is determined for the image or this inference output may be used to provide for semantic segmentation of the underlying image in order to identify one or more objects and classifications for said object(s) along with each's pixel coordinate location within the image data frame. As appreciated by those skilled in the art, semantic segmentation is a computer vision task that involves classifying each pixel (or area of pixels) in an image into a predefined category. Unlike image classification, where the entire image is assigned a single label, or object detection, where bounding boxes are predicted around objects of interest, semantic segmentation provides a dense, pixel-wise label prediction. The inference output of a semantic segmentation model is typically a multi-channel image (or tensor) of the same spatial dimensions as the input, where each channel corresponds to the likelihood of a pixel belonging to a particular category. This output can be converted to a human-readable segmentation map by assigning each pixel to the category with the highest likelihood. And, in embodiments, object detection techniques may be used to identify bounding boxes surrounding detected objects within the image data frame; such bounding boxes may be rectangles defined by four vertices, each corresponding to a pixel coordinate location within the image data frame. The method 250 continues to step 254.

In step 254, when the trigger condition is satisfied, sensor retraining data is identified based on the inference output of the ML model for which the trigger condition was satisfied. As mentioned above, the trigger condition may pertain to the inference output as the trigger condition may include monitoring one or more aspects of the inference output or data derived therefrom.

In one embodiment, a trigger condition is defined in order to detect objects disappearing from the image data feed. Here, “disappearing”, when used in connection with an object, refers to when the object is determined to be inexplicably absent. Disappearing may result from occlusions, abrupt changes in illumination, sensor noise, or false positives in which an object is not detected but is actually present within the scene captured by the image data feed. Notably, techniques for determining whether an object disappears include: determining an object trajectory from a series of object detection results performed on previous images of the image data feed; and when an object is located within a predetermined distance from an edge region of the image data frame. In one embodiment, a perimeter boundary is set that is defined by a predetermined amount of pixels or percentage of pixel range (in a given direction, such as 10% of the height and/or 10% of the width, for example) from an edge of the field of view (image data frame), such as within 150 pixels running along the bottom, top, left and right edges; for example, when an object is within this region, such as in the middle of the field of view, and then the object subsequently is not within the field of view, the object is considered to disappear. In such cases, the disappearance is often attributable to the object moving out of the camera's field of view. This eliminates any disappearances that relate to objects naturally moving out of the FOV (Field of vision)—Objects cannot physically disappear in the middle of the screen. The boundaries are set at 10% pixel range from the four edges.

Additionally, in some embodiments, the classification of the object is taken into consideration for determining whether the object has disappeared—for example, where the object is mobile (e.g., human, dog, robot vacuum), more stringent detection criteria may be used as such objects are not expected to move out of the frame. However, when a mobile object is detected within a predetermined proximity (e.g., pixel distance) of the immobile object, this may be taken into consideration and said immobile object treated as a mobile object. Of course, variations of said disappearing object detection may be implemented and tailored to the use case in which the method 250 is being used.

In such embodiments, when the trigger condition is satisfied, the data input into the ML model, which includes image data of the image data stream (or sensor data of a sensor data stream), or portions thereof may be identified as the sensor retraining data. The retraining data includes the input into the ML model as well as its output and the detection or trigger result, such as object classification and its disappearance. When the trigger condition is satisfied for images within an image data feed, the image data for the images may be manually inspected or processed using a more robust ML model or pipeline, such as through use of a larger and/or deeper model that is more accurate and that may use multiple models and/or multiple iterations of inference. Such an ML model is fine-tuned, trained, or otherwise configured to prioritize accuracy over latency. This offline process is used to achieve more accurate labels on the retraining data, which may include the data associated with satisfying a trigger condition. This more robust ML model or pipeline has a more powerful model (in terms of accuracy), although said model may be of a much larger size than the ML model used for real-time inference. Accurate labels may thus be determined for the image data of the image data feed for which the trigger condition was satisfied and such labels included as a part of the sensor retraining data. After this ML model produces labels, the labels may be inspected manually by a human, who may correct the labels as needed. This process speeds up the labeling process with automatic labels generated with the deeper model. False positives and occlusions are corrected in part by the model and also by the human during manual review. The method 200 continues to step 255.

In step 255, similarity amongst the initially-identified retraining data (from step 254) is determined and used to generate a reduced retraining set. In embodiments, this step 257 includes processing all the image data satisfying the trigger (step 254) in order to identify features across images, such as by using mathematically-determined distances between feature spaces for respective image data frames, particularly, for example, through use of cosine distance, mahalanobis distance, and/or other suitable or appropriate measures. This comparison is used to reduce the set of retraining data to be used for retraining; more particularly, image data having determined distances below a predetermined threshold are considered to be similar enough such that one of these images is discarded and not used for retraining while the other may be used for retraining. This is useful in extracting feature sets (processed image data) having the highest available signal. The method 200 continues to step 256.

In step 256, the ML model is retrained using the identified sensor retraining data. In embodiments, this may include performing one or more unsupervised and/or one or more supervised training techniques using the identified sensor retraining data as training data. In some embodiments, a technician may configure certain trigger conditions for use in step 252 and/or training parameters for the ML model according to the application for which the ML model is used. The retraining of the ML model may be performed by at least one processor of the ML retraining subsystem 24. The retraining process seeks to extract representations of various objects through contrastive learning techniques so foundation models for various contexts can be learned. The method 200 continues to step 258.

In step 258, the ML model, as retrained, is deployed to one or more of the plurality of sensor data processing servers. The ML model, as retrained, (or the “retrained ML model”) is used by the one or more sensor data processing servers to process sensor data streams, at least according to embodiments. The retrained ML model may be redeployed using a variety of techniques. In one embodiment, a basic redeployment process may be carried out for this step where parameter values are sent and used to update the processing server(s). In another embodiment, the entire retrained ML model (and/or portions thereof) may be serialized and/or otherwise packaged and sent to the sensor data processing subsystem 22 so as to update the one or more processing servers with the retrained ML model. Of course, other redeployment and/or update techniques may be used for this step, at least according to embodiments. The method 250 then ends.

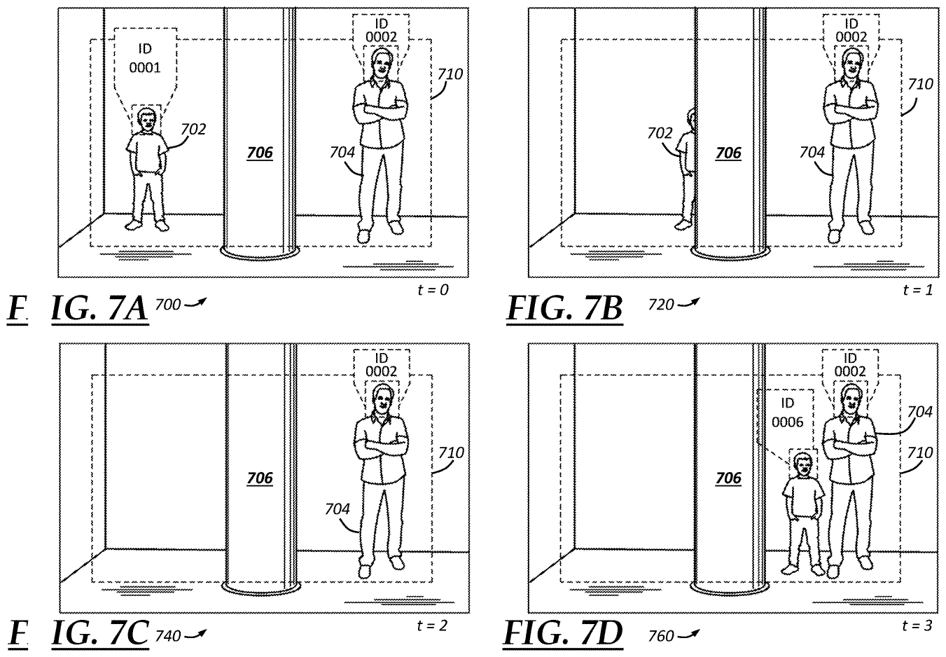

FIGS. 7A-7D depict images from an image data stream showing a scene and are discussed, in exemplary fashion, so as to illustrate various image processing that may be applied to determine whether the trigger condition is satisfied. The images 700,720,740,760 shown in FIGS. 7A-7D were captured at four different times t=0 . . . 3 and are included as a part of a single image data stream. The first image 700, which corresponds to a first image frame of an image data stream and having a time t=0, depicts two individuals 702 and 704 standing in a room on different sides of an obstruction 706. At a next time step, t=1, which is shown in FIG. 7B, a second image 720 depicts the first individual 702 partially behind the obstruction 706 and, at time step t=2 as shown in FIG. 3, a third image 740 depicts a scene without the first individual 702. Finally, at time step t=3, a fourth image 760 depicts the first individual 702 appears again, on an opposing side of the obstruction 706.

In some embodiments, the real time activity trigger condition is based on tracking individuals or objects in a scene, such as tracking the individuals 702,704 through the scene as shown in the images 700,720,740,760. In one embodiment, the real time activity trigger condition is based on whether an individual disappears from a central part of the field of view of the image data, which is defined as being that portion within a 10% band that runs around the perimeter of the image data; for example, band 710 extends around (and defines) a central portion of the image 700,720,740,760.

In embodiments, the real time activity trigger condition is whether an anomaly is detected in the image data stream, where the anomaly is based on a negative detection of an individual within the image data stream; according to one embodiment, in particular, for example, the anomaly is determined based on the negative detection being uninterrupted for a predetermined period of time and/or based on two proximate frames being ones in which a first frame or image depicts an individual is identified in a middle portion of a scene and a consecutive, second frame or image depicts the individual not within the scene (i.e., the scene without the individual (or at least without a recognizable portion of the individual)). The two proximate frames may be any two consecutive frames from the same capture device and may have any suitable number of intervening frames therebetween; that is, the two proximate frames are within a predetermined number of intervening frames (e.g., one intervening frame) and/or a predetermined period of time, which is selected as being less than five seconds, in some embodiments; however, the predetermined period of time, and other aspects of the trigger condition, may be selected and configured according to the application in which it is to be used. In some embodiments, this individual identification process further includes an individual identity reconciliation process that determines whether a detected individual is the same (or likely to be) the same individual previously identified. In embodiments, the individual identity reconciliation process includes evaluating one or both criteria discussed below with respect to method 1700 (FIG. 17).

For example, with reference to FIGS. 7A-7D, the first individual 702 is identified as ID 0001 and the second individual 704 is identified as ID 0002; these IDs are each an identifier that is assigned to each individual and that is unique to each individual. As seen in FIGS. 7B-7C, an individual-identifying portion of the first individual 702 (corresponding to the face of the individuals 702,704 in the example of FIGS. 7A-7D), is obscured by the obstruction 706 and the individual 702 is no longer able to be recognized. In FIG. 7D, an individual appears and is assigned ID 0006. In embodiments, an individual identification process is used to identify individuals within the image data stream and may be used as a part of an individual tracking process is used to track the individuals. In embodiments, deep feature extraction and comparison or byte tracking based on distance is used to track individuals using identifiers. According to one embodiment, the real time activity trigger condition is: an individual is present in a central portion of the image data stream and, within a predetermined amount of time or frames thereafter, the individual is not present or identified/identifiable within the image data stream.

In one embodiment, the individual identification process includes the individual identity reconciliation process, which determines whether a detected individual is the same (or likely to be) the same individual previously identified. For example, the individual that appears in FIG. 7D may initially be identified with a new identifier ID 0006 (such as when the time when the individual identified as ID 0001 was not in view); however, the individual identity reconciliation process may be carried out and, in embodiments, includes comparing feature vectors generated based on portions of image data corresponding to two individuals. In one embodiment, the feature vectors are developed using a sensor data feature extraction technique in which a feature vector is extracted from the sensor data using a deep neural network (DNN), at least in embodiments.

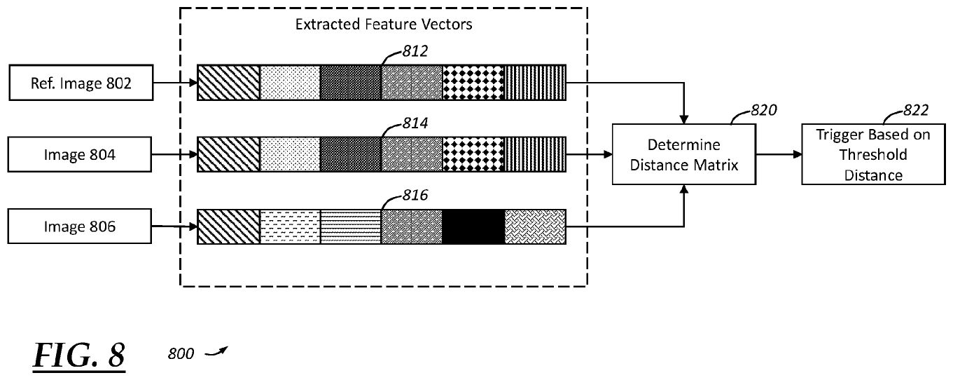

With reference to FIG. 8, there is shown a sensor data feature extraction trigger process that includes determining a feature vector 812,814,816 for each of a reference image 802, a first image 804, and a second image 806, respectively. In embodiments, the feature vectors may be determined using any of a variety of suitable ML techniques, such as, for example, using neural networks (NNs), such as convolutional neural networks (CNNs). Once the feature vectors 812,814 are generated, a reference-first image distance between the reference image feature vector 812 and the first image feature vector 814 is determined; likewise, when the feature vectors 814,816 are generated, a first-second image distance between the first image feature vector 814 and the second image feature vector 816 is determined as shown at operation 820. A detected feature difference between the reference-first image distance and the first-second image distance is determined and compared to a threshold amount, as shown at operation 822; in embodiments, when it is determined that the detected feature difference exceeds a threshold, such as a predetermined threshold value, then the trigger is considered to be triggered. In embodiments, triggering of the trigger means that the two compared images have similar underlying image data with respect to the trained feature(s) or classifier(s), which may be unique recognition (e.g., facial recognition) of individuals. In embodiments, when triggered at 822, then it is determined that an individual depicted in the first image 804 is the same individual as in the second image 806. In embodiments, the reference image 802 may be an image taken from the camera without any individuals within the field of view. In other embodiments, other reference images may be used. In embodiments, the first-second image distance and/or other data determined using the method 800 may be used to trigger a retraining process using the inputted data, or the image data of the first and second images 804 and 806 (and potentially of the reference image 802). For example, when occupancy counts indicate that an individual is likely to be in a given zone and, at the same time, an unidentified individual appears, then the circumstances may indicate that the unidentified individual is the individual likely to be in that zone, even if the trigger of step 822 did not occur. In such a circumstance, the input data (image data of the first image 804 and the second image 806) is used for retraining the ML model that is used to generate the feature vectors. This may be performed by the retraining process described herein and the ML model may be automatically deployed once retrained, in embodiments.

With reference to FIG. 9, there is shown a method 300 of configuring an image processing system to track an entity's movement between zones. The method 300 is performed by an image processing system having at least one processor and memory accessible by the at least one processor, and the memory stores computer instructions that, when executed by the at least one processor, cause the image processing system to perform the steps of the method 300. According to embodiments, the method 300 is carried out by the sensor data processing system 14, include using one or more processors thereof. In some embodiments, multiple executions of one or more steps, such as of steps 310 and 320, may be performed and/or simultaneously for same or differing iterations of the method 300; for example, according to one embodiment, the steps 310 and 320 are carried out a plurality of times thereby resulting in identifying a plurality of spatial relationships between spatial regions (or zones) based on the received image data and step 330 may be carried out once as a part of the method 300 to generate a directed network graph using the plurality of spatial relationships determined using the multiple iterations of steps 310-320.

The method 300 begins with step 310, wherein a plurality of image data streams each having image data captured by a camera are received, and wherein at least two of the plurality of image data streams have overlapping fields of view in which an overlapping zone is defined. The image data streams may correspond to image data streams 34-f above, for example. The image data streams include image data, such as data from a digital camera, that includes images of areas or regions, such as areas around or within buildings, streets, public places, etc. The overlapping zone of a first and second camera would correspond to a region or area within a field of view of both the first and second camera. The method 300 continues to step 320.

In step 320, a spatial relationship between spatial regions is identified based on the image data of the image data streams. According to embodiments, a spatial relationship between spatial regions within a field of view of the plurality of image streams is identified based on processing the plurality of image data streams. A spatial relationship between spatial regions refers to an indication of a presence, orientation, position, and/or distance of two spatial regions relative to each other, such as two cameras having a field of view with a common spatial region or two cameras having fields of view that are proximate to one another. The spatial relationships may be predetermined or predefined by a user, such as through specifying zone configuration data using a graphical user interface (GUI). In other embodiments, spatial relationships may be learned automatically by the system through tracking an entity through fields of view of cameras co-located, such as cameras 0-9 (FIG. 9). In some embodiments, the spatial relationship may simply be a flag indicating whether two spatial regions are within a predetermined distance of one another and/or at the same general location, which may be defined according to the application in which the directed network graph is to be used. For example, in at least some embodiments, the directed network graph is used to track an entity's movement between zones; in such embodiments, the spatial relationship of two spatial regions may be determined based on whether it is reasonable for a person to move between the two spatial regions within a predetermined amount of time, such as five seconds, for example; here, in this example, the spatial relationship between the two spatial regions may be identified by a flag being set to true, provided the two spatial regions meet the criteria; otherwise, the flag is set to false. Here, where the flag is true, the spatial regions are said to be adjacent to one another and may be connected to one another when represented by a directed network graph. Of course, various other information, such as distance values and/or other information may be determined as a part of the spatial relationship data, in some embodiments.

In some embodiments, such as where zone configuration data is not predefined or initially specified by a user, the zone configuration data may be learned or automatically determined by the system through an automatic zone learning process in which an identified object or entity is tracked using object recognition/entity tracking techniques and image data streams from a plurality of co-located cameras are then processed and matched up in terms of time in order to determine a spatial relationship (e.g., spatial adjacency) between zones, which may each correspond to a field of view of a camera, in embodiments. In such embodiments, this step may thus include processing the plurality of image to identify the spatial relationship between spatial regions within the field of view of one or more of the image data streams. The spatial relationship may merely indicate one or more zones or regions identified to be present within a field of view of the camera. Spatial relationship data may be stored (such as zone configuration data), and this data may include an indication of the presence of particular zones or regions within a field of view of an image data stream. The method 300 continues to step 330.

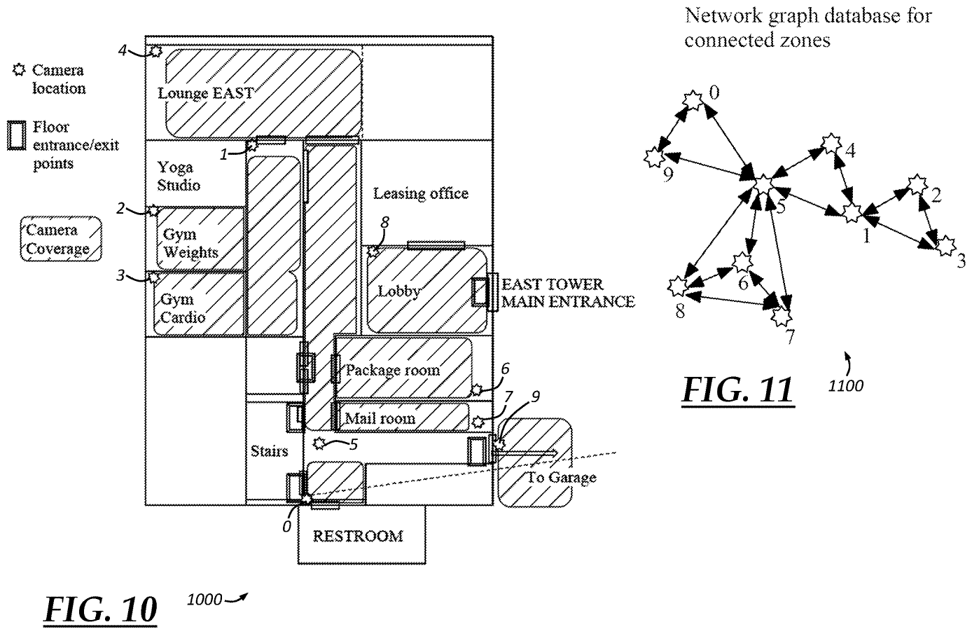

In step 330, a directed network graph representing the identified spatial relationships is generated and, according to embodiments, a node represents a zone and an edge represents a spatial proximity between associated zones of connected nodes. The directed network graph includes a plurality of nodes and edges, where each node (or at least a plurality thereof and, in some embodiments, every node) represents a zone and each edge between nodes represents a spatial relationship between the connected nodes. Accordingly, with reference to FIGS. 10-11, there is shown an example in which 10 cameras (which are labeled 0-9 in FIGS. 10-11) are located through a floor of a building that has five floor entrance/exit points; in particular, FIG. 10 depicts a plan view 1000 of the floor of the building and FIG. 11 depicts a directed network graph 1100 that is generated. The directed network graph 1100 includes a node for each camera 0-9 and an edge is present between the nodes based on the spatial relationship; in particular, in the example shown in FIG. 11, the directed network graph 1100 is based on whether an individual may pass between a field of view of a first camera and a field of view of a second camera within a predetermined amount of time and/or without first being present in a field of view of yet a third camera; for example, in the FIG. 10 example, an individual is not likely to be identified in image data from camera 8 at a first time; identified in image data from camera 0 at a second time (e.g., a time that is soon after (e.g., a few seconds; can be adjusted based on the application/implementation)) without being identified in image data from camera 5 at a time between the first and second time. The method 300 continues to step 340.

In step 340, the image processing system is configured to track an entity's movement between zones through use of the directed network graph. The directed network graph may be used to determine information about one or more entity tracks, which are tracks between zones through which an entity moves; for example, a person may walk from the first zone (defined by the field of view (FOV) of camera 1 in FIGS. 10-11, for example) to the fifth zone (defined by FOV of camera 5) and then to the eighth zone (defined by the FOV of camera 8). The directed network graph may be queried to determine whether this travel path or “entity track” is plausible—for example, since there is an edge between the first zone and the fifth zone and between the fifth zone and the eighth zone, then this may indicate this is not an anomalous path; in another example where an individual is detected as moving from the ninth zone (defined by the FOV of camera 9) to the fifth zone and then to the third zone (defined by the FOV of camera 3), then this may indicate an anomalous path or an error in the classification/recognition of the entity and/or in the entity track determination process since there is no edge between the fifth camera 5 and the third camera 3. In some embodiments, the outputs generated using the directed network graph may be monitored for different purposes, such as for anomalous path detection. In embodiments, a trigger condition is set to trigger when an anomalous path is detected based on an inputted entity track lacking an edge between two time-adjacent spatial regions or zones; here, time-adjacent refers to two spatial regions or zones of a track (such as an entity track) that immediately precede/follow one another in terms of time; for example, in the example above where the individual travels from the first zone to the fifth zone to the eight zone, the first zone and the fifth zone are time adjacent, as are the fifth zone and the eighth zone, but the first zone and the eighth zone are not. In some embodiments, when a trigger condition based on an output of the directed network graph is triggered, then certain input data associated with the output may be identified and used for a feedback process, such as an ML retraining process using the ML retraining subsystem 24, for example.

In some embodiments, image data streams are processed using the sensor data processing subsystem 22 described above, which uses a ML model for generating an inference output. In embodiments, the inference output may be used to generate an entity track, and may include object recognition and/or other image processing techniques. The inference output may indicate, for example, spatial relationship data indicating information about spatial relationships among a plurality of spatial regions or zones. According to some embodiments, the image data stream input into the processing server (or ML model) is identified as ML retraining data when the trigger condition is satisfied, such as when an anomalous entity track is identified. The method 300 then ends.

With reference to FIG. 12, there is shown a method 1200 of determining occupancy information for a region that includes occupiable portions (i.e., zones/areas that are occupiable by a human being) not within a field of view. In embodiments, the occupancy information includes an occupancy count (a number of human beings), for the region, which may be a room or corridor within a building, for example. The image data stream includes time-series image data and is processed to identify individuals or humans using object recognition/identification techniques, such as deep feature extraction and comparison and/or byte tracking. For each identified individual, the detection steps of 1210 through 1230 may be used and the occupancy information (e.g., occupancy count) updated in accordance with that processing.

The method 1200 includes use of two occupancy line boundaries, which each is a boundary formed of a line that extends across the image data. For example, with reference to FIG. 13, there is shown an example of an image data stream 1300 having a first image frame 1302 that includes a first occupancy line boundary 1304 and a second occupancy line boundary 1306. The first occupancy line boundary 1304 and the second occupancy line boundary 1306 are parallel to one another and are spaced apart an occupancy line spacing distance that is at least 33% of the height or at least 50% of the width of the image frame 1302, whichever is smaller; for example, for an image having 3000×5000 pixels, then the first occupancy line boundary 1304 and the second line boundary 1306 are spaced apart by at least 1100 pixels (3000*33%). In other embodiments, the occupancy line spacing distance is at least 50% of the width or height of the image frame 1302, whichever is smaller. The image frame (or field of view) may be divided into sections or portions based on one or more occupancy boundary lines. For example, with respect to the example of FIG. 13, there is shown a first entrance/exit portion 1303 that spans the area between the border of the image frame 1302 and the first occupancy boundary line 1304 as well as a second entrance/exit portion 1307 that spans the area between the border of the image frame 1302 and the second occupancy boundary line 1306. Further, an enclosed portion 1305 spans the area between the first occupancy boundary line 1304 and the second occupancy boundary line 1306. It should be appreciated that the floor entrance/exit points shown in FIG. 10 are different from entrance/exit portions of an image data stream, such as the entrance exit portions 1303,1307. Although each of the entrance/exit portions 1303,1305,1307 are shown as being rectilinear (particularly, rectangular), it should be appreciated that, the portions 1303,1305,1307 may be shaped differently depending on the shape and orientation of the occupancy boundary lines.

The example image data stream 1300 shown in FIG. 13 is but one example where a walkway or a pathway leading to an entrance or exit (e.g., a doorway) is oriented generally in the vertical direction and, in such instances, the first occupancy line boundary 1304 and the second occupancy line boundary 1306 are oriented horizontally or perpendicular to the walkway or pathway extending from a hallway toward the top of the image data stream 1300 and downwardly to the entrance/exit at the bottom of the image frame 1302. The walkway or pathway leading to an entrance or exit in an image data stream is referred to as an entrance/exit pathway. In other embodiments, such as where an entrance/exit pathway extends generally horizontally across the image data stream 1300, the occupancy line boundaries may be oriented vertically and spaced apart horizontally by the occupancy line spacing distance. In one embodiment, the occupancy line boundaries are positioned horizontally or vertically (i.e., at 0° or 90°); however, in other embodiments, the occupancy line boundaries may be positioned at any suitable angle, which generally is perpendicular to the entrance/exit pathway. Here, “generally” refers to being within 30°. In embodiments, the occupancy line boundaries are straight lines; however, in other embodiments, the occupancy line boundaries may be curved lines and/or have one or more vertices. In embodiments employing curved lines for the occupancy boundary lines, the occupancy boundary lines may run parallel to one another.

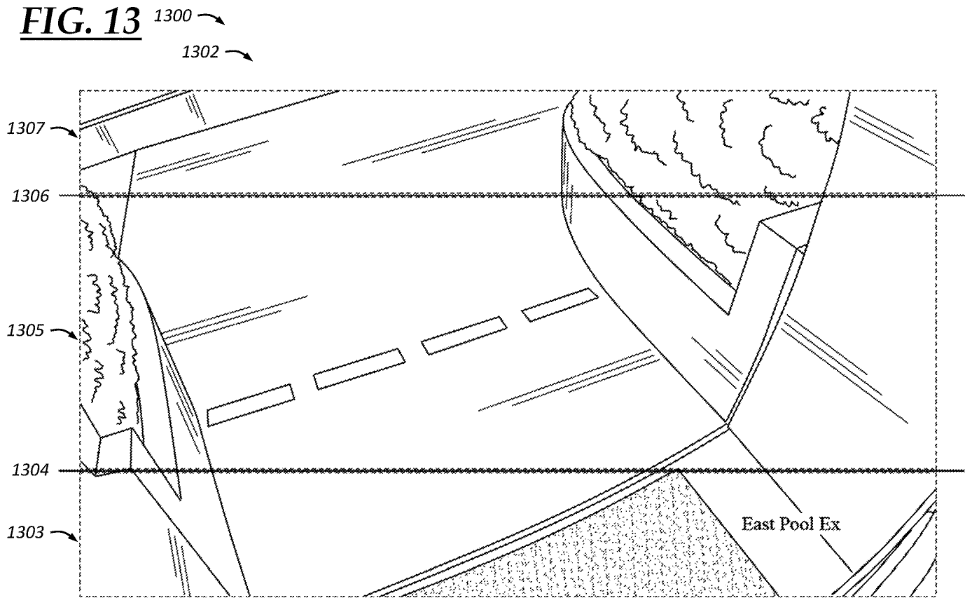

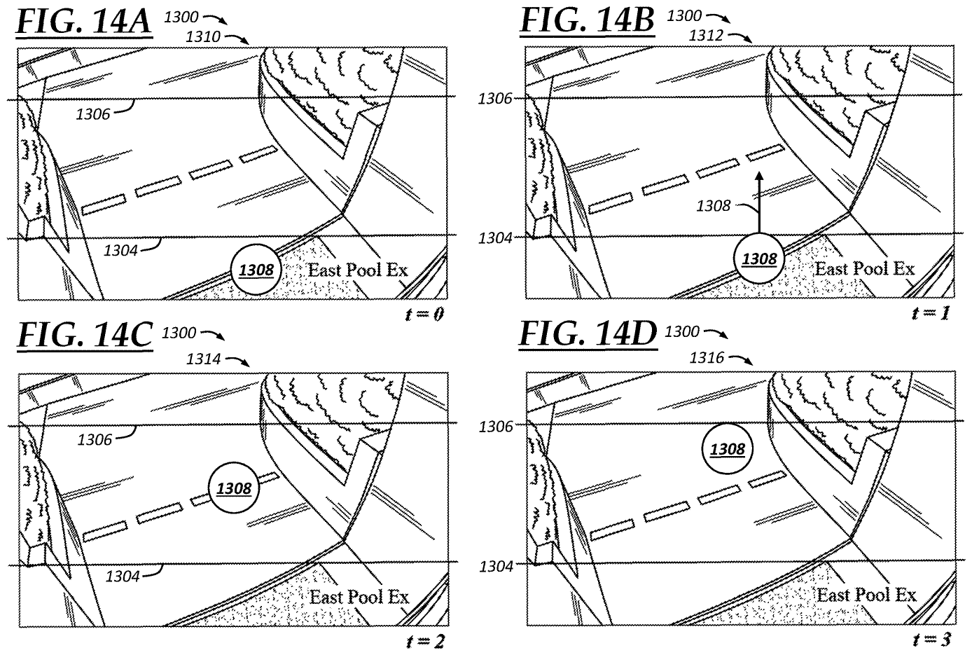

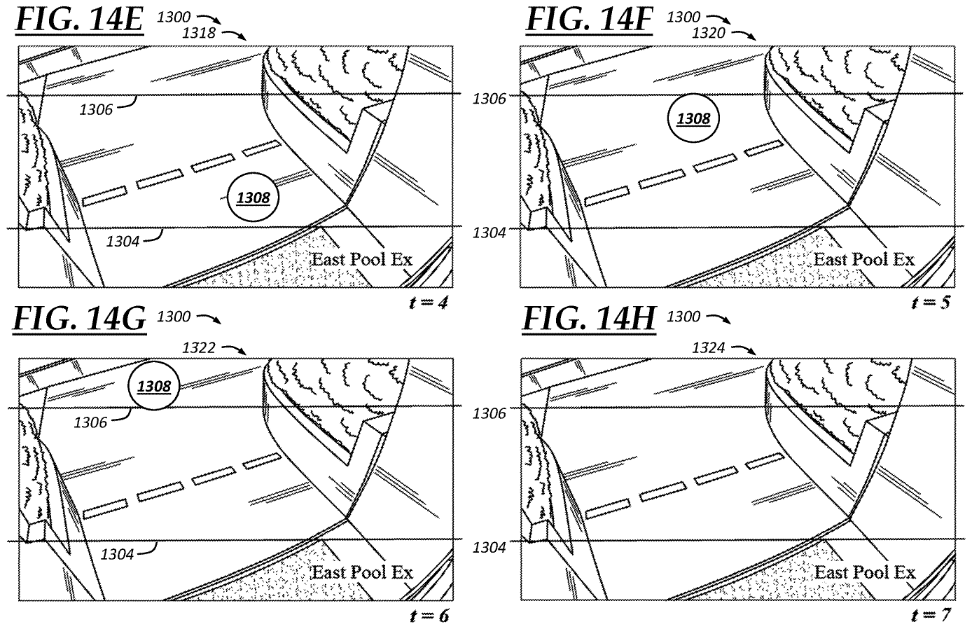

With reference now to FIGS. 14A-H, there is shown a plurality of image frames 1310-1324 of the image data stream 1300, including the first occupancy line boundary 1304 and the second occupancy line boundary 1306. In some of the frames, namely image frames 1310-1322 in FIGS. A-G, there is shown an individual 1308 that travels between locations and where the circle 1308 in FIGS. A-G indicate a face or other identifying portion of an individual. The image frames 1310-1324 are ordered as a time series as indicated by the time indicator in the bottom left (e.g., in FIG. A, t=0). The scenario illustrated in FIGS. 14A-H is referred to in the discussion of the method 1200 below for purposes of providing an illustrative example.

With reference back to FIG. 12, the method 1200 begins with step 1210, wherein an individual crossing a first occupancy line boundary is detected based on processing an image data stream. The image data stream is processed using object recognition and/or human identification techniques to identify one or more individuals within a field of view of the image data stream. In embodiments, a pixel location (or area) of the identified individual may be determined for a series of image frames over time (or a time series of image frames), such as identifying a pixel location of the individual 1308 in the image frames 1310-1322 shown in FIGS. 14A-H. Pixel location data, which specifies information regarding the pixel location, of the individual may be used to determine whether the individual crossed the first occupancy line boundary. For example, with respect to the example shown in FIGS. 14A-H, the individual 1308 first contacts the first occupancy line boundary 1304 at time t=1 in the second image frame 1312 (FIG. 14B).

In some embodiments, the method 1200 is initiated in response to detecting an individual enter the field of view (or an image frame) of the image data stream, which may include the use of object recognition techniques, for example. In some embodiments, in addition to determining the individual crossed the first occupancy line boundary, a determination is made as to whether the individual originated before the first occupancy line boundary. In some embodiments, this determination is performed by determining whether the individual is located within an entrance/exit portion of the image frame, such as the first entrance/exit portion 1303 or the second entrance/exit portion 1307 (FIG. 13). The method 1200 continues to step 1220.

In step 1220, a direction of the individual is determined and, in embodiments, this may include determining a location of the individual within image frames of the image data stream and then determining a heading or direction between the two locations. For example, a direction 1309 of the individual 1308 is determined for time t=1 (FIG. 14B) based on determining a location of the individual within the image frames 1310 (FIG. 14A, t=0) and 1312 (FIG. 14B, t=1). In other embodiments, other mechanisms for determining the direction of the individual is determined. In embodiments, a direction for each image frame may be determined where a location of the individual is determinable at two time steps, such as at time t=1 . . . 7 (FIGS. 14B-H). The method 1200 continues to step 1230.

In step 1230, the individual crossing a second occupancy line boundary is detected based on processing an image data stream. The first occupancy line is different from and not connected to the first occupancy line boundary. For example, in FIGS. 14A-H, the first occupancy line boundary 1304 is toward a bottom one-third of the image frames 1310-1324 (which corresponds to the field of view (FOV) of the camera) and the second occupancy line boundary 1306 is toward a top one-third of the image frames 1310-1324. The detection of the individual crossing the second occupancy boundary line is performed in the same manner as detecting the individual crossing the first occupancy boundary line as discussed in step 1210. The method 1200 continues to step 1240.

In step 1240, occupancy information for a region that includes occupiable portions not within a field of view is determined. In embodiments, in response to the detection in step 1230, a count is modified (e.g., incremented, decremented) and this count, which is occupancy information, indicates a number of individuals within a particular occupiable portion, such as a corridor or room of a building. The method 1200 then ends.

In embodiments, the method 1200 is performed for each of a plurality of different image data streams that are generally co-located with one another, such as the cameras 0-9 shown in FIG. 10. In some embodiments, for example, a location at which the cameras are co-located may be divided into one or more zones, including one or more occupiable portions that are not (or not substantially—i.e., 70% of FOV) within a field of view of any camera of the system. For example, with reference to FIG. 10, the “Yoga Studio” is an occupiable portion that is not within a field of view of any of the cameras 0-9; however, an image data stream from cameras 1, 2, and 3 may be processed according to the method 1200 so as to determine occupancy information for the occupiable region corresponding to the “Yoga Studio” of FIG. 10. For example, individuals may enter the “Yoga Studio” from the hallway at which camera 1 is located and that is within the FOV of camera 1. The occupancy information (determined using the method 1200) from camera 1 may be sufficient to determine whether an individual is within the corridor having the Yoga Studio and the two other rooms that have the cameras 2 and 3 (the two small “Gym Weights” and “Gym Cardio” rooms below the “Yoga Studio”). However, using occupancy information from cameras 2 and 3, when used along with the occupancy information from camera 1, may provide sufficient information to determine whether an individual is within the “Yoga Studio”.

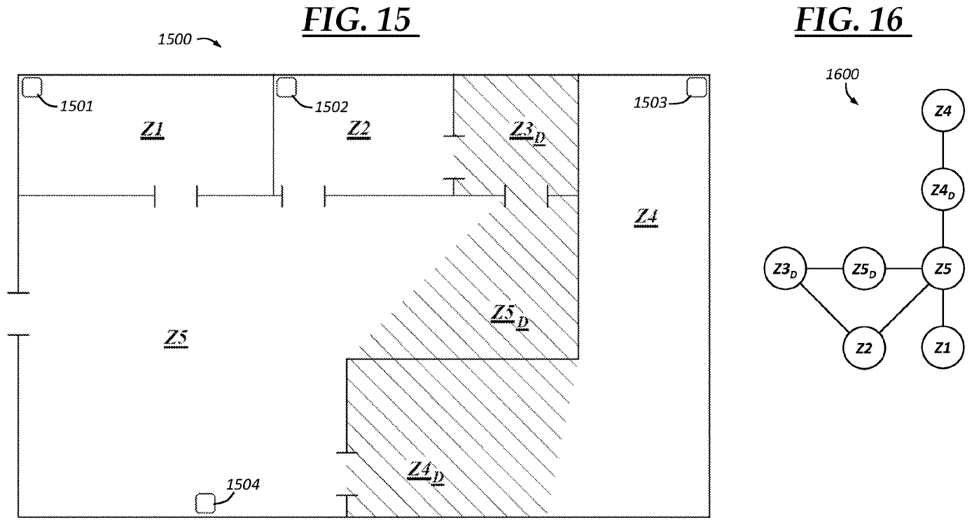

With reference to FIGS. 15-16, there is shown an example in which four (4) cameras 1501-1504 are located through a floor of a building that has one floor entrance/exit point; in particular, FIG. 15 depicts a plan view 1500 of the floor of the building and FIG. 10 depicts a directed network graph 1600 that is generated. The plan view depicts the four cameras 1501-1504 located in different rooms that are connected by doorways and that is divided into zones Z1,Z2,Z3_{D},Z4,Z4_{D},Z5,Z5_{D}, which include camera-FOV zones Z1,Z2,Z3_{D},Z4,Z5 (or Z1-Z5) and camera dark zones Z4_{D},Z5_{D}. A camera-FOV zone is a zone corresponding to a region that is within a field of view of a camera and a camera dark zone is a zone that is not a camera-FOV zone and that corresponds to a region not within a field of view of any camera used. The directed network graph 1600 includes a node for each zone Z1,Z2,Z3_{D},Z4,Z4_{D},Z5,Z5_{D} and an edge is present between the nodes based on the spatial relationship, such as that which is described above with respect to the method 300. The directed network graph 1600 is analogous to the directed network graph 1100 and that discussion of the directed network graph 1100 is hereby attributed to the directed network graph 1600 to the extent such discussion is not inconsistent with the express discussion of the network graph 1600.

With reference to FIG. 17, there is shown a method 1700 of determining occupancy information for a region having a plurality of zones spatially connected to one another. The method 1700 is performed by an image processing system having at least one processor and memory accessible by the at least one processor, and the memory stores computer instructions that, when executed by the at least one processor, cause the image processing system to perform the steps of the method 1700. According to embodiments, the method 1700 is carried out by the sensor data processing system 14, include using one or more processors thereof. In some embodiments, multiple executions of one or more steps may be performed and/or simultaneously for same or differing iterations of the method 1700.

The method 1700 begins with step 1710, wherein an object within an image data stream is detected. The image data stream may be referred to as a first data image stream and the first data image stream includes image data captured by a first camera. According to at least some embodiments, detecting the object includes using object recognition techniques to process the image data of the first image data stream to determine an object class of the object and, in particular, according to some embodiments, determine whether the object is a human based on the object class. In one embodiment, for example, object recognition techniques are used to determine certain attributes about objects within an image or an image stream/video. The attributes may indicate a classification of the type of object, such as a dog, a person, etc. In some embodiments, when it is determined that the object is not (or is likely not (i.e., below a predetermined confidence level)) a human, then the method 1700 may end, such as in embodiments where the occupancy information is used for occupancy counts of only humans. In other embodiments, the detected objects are tagged (associated or labeled) with the determined object class, and occupancy count information may be determined for (or subdivided by) object class. The method 1700 continues to step 1720.

In step 1720, updated occupancy count information for a zone (or first zone) of the plurality of zones is determined based on occupancy count information for the zone and one or more adjacent zones. The first image data stream corresponds to the first zone in that the first zone is included within a field of view of images of the first image data stream (corresponding to the field of view of the first camera). In embodiments, each of the one or more adjacent zones is identified as an adjacent zone for the first zone based on being spatially adjacent to the first zone. In some embodiments, each of the one or more adjacent zones is identified as an adjacent zone for the first zone based on querying a directed network graph using the first zone. With reference to the example shown in FIGS. 15-16, when the first zone is zone Z5, the adjacent zones returned by the directed network graph 1600 would be zones Z1,Z2,Z4_{D},Z5_{D}. The directed network graph 1600; for zone Z2, the adjacent zones are zones Z3_{D},Z5.

As mentioned above, the directed network graph may represent spatial relationships between the plurality of zones, where a node represents a zone and an edge represents a spatial proximity and/or adjacency between associated zones of connected nodes. In embodiments, determining the occupancy count information for the region includes: determining that the identified object is not within the image data stream for the first zone for a predetermined amount of time; and/or determining that the identified object is not within an image data stream for the one or more adjacent zones for the predetermined amount of time. The predetermined amount of time may be set based on characteristics of the zone; for example, the predetermined amount of time for a camera-FOV zone may be set to a first predetermined amount of time and the predetermined amount of time for a camera dark zone may be set to a second predetermined amount of time that is different than the first predetermined amount of time. The time window is set based on characteristics of the zone that include one or more of the following: an area of the zone within an image data stream, a floor plan area (e.g., an area using a floor plan, such as those examples shown in FIGS. 10 and 15), average time taken to walk through the zone, and a walking path length of a walking path through the zone. In some embodiments, the predetermined amount of time may be determined automatically prior to the method 1700 based on the characteristics of the zone. A user may then edit or modify the time windows to set custom values for the time windows.

In embodiments, as a part of determining the updated occupancy count information, occupancy count delta values are obtained for each zone and each occupancy count delta value indicates change in occupancy count (represented as an integer, for example) for the zone within a time window, which may be predefined as a predetermined amount of time. When the first zone is Z5, then the occupancy count delta values of the adjacent zones are Z1,Z2,Z4_{D},Z5_{D} are compared with the occupancy count delta value for the zone Z5. In an example using a time window of 15 seconds and with the occupancy count delta values [Z5: 1, Z2: −1, Z1 i: 0, Z4_{D}: 0, Z5_{D}: 0], then the net value (1+(−1)+0+0+0) is 0, which indicates consistency in identification of individuals. In another example with the occupancy count delta values [Z5: 1, Z2: −1, Z1 i: 0, Z4_{D}: 0, Z5_{D}: 0], then the net value (1+(−3)+1+0+0) is −1, which indicates that a previously-identified individual is unaccounted for; in such a scenario, where the method 1700 identifies an individual (step 1710) in the first zone (here, Z5), then the occupancy count delta values are determined and used to identify an individual. For example, in the previous example having a net value of −1 for the first zone (being Z5 in this example) in a time window, when a new individual is detected in the window in the first zone (step 1710), then it may be determined that the individual is likely from an adjacent zone rather than, for example, having entered from an exit/entrance way to the building. The method 1700 continues to step 1730.

In step 1730, updated occupancy information for the region is determined based on the updated occupancy count information. In embodiments, the occupancy information includes updated occupancy count information for the region and, specifically, updated occupancy count information for the first zone and at least one of the one or more adjacent zones. In embodiments, the updated occupancy information for a zone is determined based on two criteria: the object type being a predetermined type (e.g., human) and occupancy counts for the zone and an adjacent zone. For the first criteria, this determination may be made as discussed above. For the second criteria, a determination may be made as to whether there was an observed changed in occupancy counts in an adjacent zone such that an individual in the adjacent zone likely moved out of the adjacent zone and potentially into the zone. For a given zone, an individual may move out of the image data stream and, when it is determined that the individual moved out of the image data stream for a predetermined amount of time and occupancy counts for adjacent zones indicate that the individual is not within the respective adjacent zone, then it is determined that the individual is within the given zone (and likely occluded from view so as to be unrecognizable/unidentifiable, such as is the case of the individual 702 in FIG. 7C). The occupancy determination process 1200 may be used to determine occupancy counts for use in assessing the above-described second criteria and/or for any other occupancy counts discussed herein. The method 1700 ends.

In embodiments, when an individual is detected (step 1710) and one or both of the first criteria and the second criteria are not satisfied, then the image data of the image data stream that was used to detect the individual (and/or other image data of the image data stream proximate in time to such image data) is flagged or marked as retraining data that may be used to retrain the ML model, such as discussed above with respect to the ML retraining subsystem 24 and ML retraining method. This criteria may thus be used as a real time activity trigger and/or anomalous trigger condition, as discussed above.

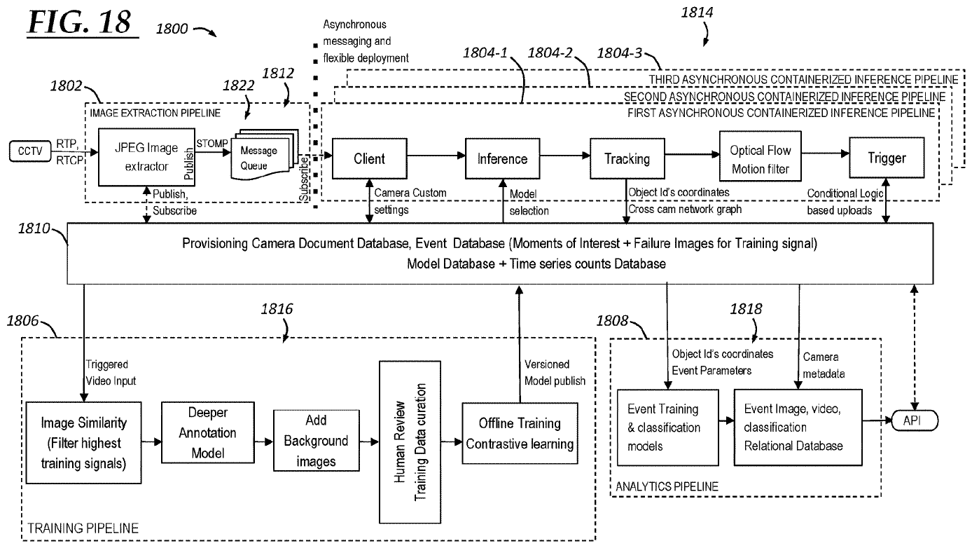

With reference to FIG. 18, there is shown an image processing system 1800 comprised of four processing pipelines, namely an image extraction pipeline 1802, a plurality of asynchronous containerized inference pipelines 1804-o (where o is from 1 to O, with O being the total number of asynchronous containerized inference pipelines, which is three (3) in the depicted embodiment), a training pipeline 1806, and an analytics pipeline 1808. The image extraction pipeline 1802 is implemented by an image extraction subsystem 1812, the asynchronous containerized inference pipeline 1804 is implemented by an asynchronous containerized inference subsystem 1814, training pipeline 1806 is implemented by a training subsystem 1816, and analytics pipeline 1808 is implemented by an analytics subsystem 1818.

Each of the image extraction subsystem 1812, the asynchronous containerized inference subsystem 1814, the training subsystem 1816, and the analytics subsystem 1818 includes at least one processor and memory storing computer instructions that, when executed by the at least one processor, cause the functionality attributed to said subsystem 1812,1814,1816,1818 to be carried out. In embodiments, the subsystems 1812,1814,1816,1818 may share hardware components, such as using a shared memory device and/or one or more shared processors.

The image extraction pipeline 1802 is used to normalize or standardize image data into a predefined image format defined by a resolution (as a two-dimensional array) and a color space (e.g., standard RGB (sRGB)) so that the received images are formatted consistently. The formatted images (represented by formatted image data) are then published to a message-subscribe model for consumption by one or more subscribers, each of which may have a different purpose and which may process the image data asynchronously relative to one another so that image data may be continuously duplicated as appropriate for supporting the subscriber(s)—such processing is represented by the asynchronous containerized inference pipeline 1804, which is discussed more below.

In embodiments, the image extraction pipeline 1802 is be deployed on a local network that the camera is a part of, and which may be referred to as a camera local network. In embodiments, the purpose of the image extraction pipeline 1802 is to extract images from the camera and populate an asynchronous messaging queue in the cloud. The image extraction pipeline 1802 takes the raw video streaming Real-Time Streaming Protocol (RTSP) format and converts this to timestamped JPEG images at a specified frames per second, which may be requisite for processing by the asynchronous containerized inference pipeline 1804, for example. The image extraction pipeline 1802 may format the raw images to have a standardize (consistent) image quality, size, resolution, and format, and then the image extraction pipeline 1802 populates the latest message into the queue with data, such as source timestamp. In at least some embodiments, each camera stream has its own queue and only the latest image is retained. The consumer applications (e.g., in this case, the asynchronous containerized inference pipeline 1804) will always get the latest image available. The image extraction pipeline 1802 also has the ability to duplicate the queue with the same camera information for a parallel consumer application. In effect, the image extraction pipeline 1802 is the bridge between the camera and the deep learning pipeline, represented by the asynchronous containerized inference pipeline 1804 in the present embodiment. The consumer pipeline (here, the asynchronous containerized inference pipeline 1804) is asynchronous and can be deployed anywhere (e.g., external data center, cloud containers, local workstation). The image extraction pipeline 1802 also allows throttling functions such as limiting FPS of images in the queue regardless of camera FPS. This enables asynchronous processing of real-time or live image data (video), even for low bandwidth camera systems.

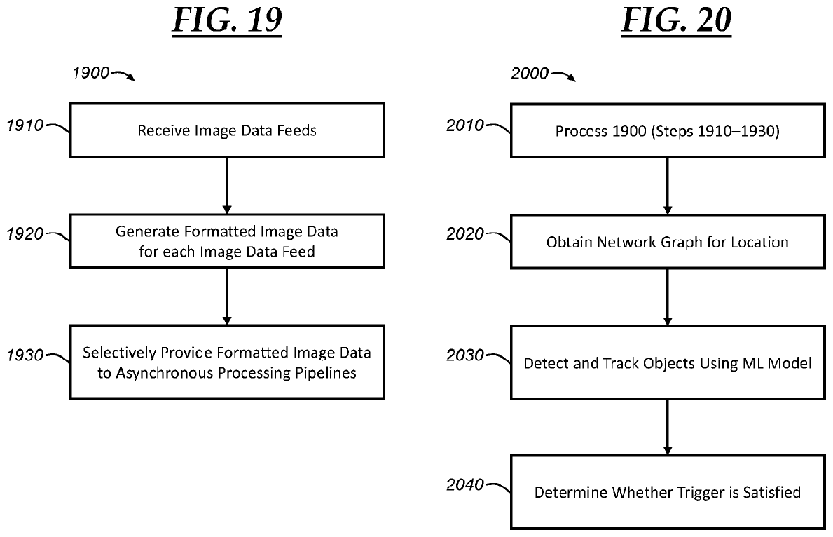

More specifically, with reference to FIG. 19, the image extraction pipeline 1802 is shown as performing an image extraction process 1900. The image extraction process 1900 begins with step 1910, wherein a plurality of image data feeds are received. In embodiments, each image data feed of the plurality of image data feeds is comprised of image data captured by a camera and in a native format of the camera. Each of the plurality of image data feeds is transmitted from the camera using a real-time communication protocol.

The real-time communication protocol is a connectionless, meaning that packets are transmitted without any formal connection being established, unlike transmission control protocol (TCP), for example. The real-time communication protocol prioritizes timeliness over reliability of packet transfer, and is better suited for real-time streaming of images/video. Such real-time connections may be built on uniform datagram protocol (UDP), such as the real-time transport protocol (RTP) defined according to Internet Engineering Task Force (IETF) Request for Comments (RFC) 3550. Such RTP transmissions may be supplemented or complemented by use of RTP control protocol (RTCP), such as secure RTCP defined according to RFC 3711. RTCP may be used to collect media distribution quality statistics during a session and shares them with all participants, aiding in adaptive encoding and fault detection. Additionally, RTCP may be used to provide stable end-point identifiers (CNAME) to participants, ensuring consistent identification, while also facilitating session control functions, unlike where only RTP is used, which results in solely source-transmitted data. The RTP/RTCP connection is established with the camera of each of the one or more image data feeds in order to receive the image data continuously and in real-time as a real-time image data stream. Other potential protocols that may be used are WebRTC (Web Real-Time Communication), RTSP (Real-Time Streaming Protocol), UDP itself, SCTP (Stream Control Transmission Protocol), WebSockets, MJPG or MJPEG (Motion JPEG), or even MQTT (Message Queuing Telemetry Transport) using WebSockets, at least in embodiments.

The plurality of image data feeds includes a first image data feed captured by a first camera that is a different make or model than a second camera that captured a second image data feed of the plurality of image data feeds. As discussed more below, the method 1900 enables processing of image data regardless of the camera's attributes, enabling single processing pipelines to be developed and used for processing image data initially formatted in a variety of different formats. The method 1900 continues to step 1920.

In step 1920, for each image data feed of the plurality of image data feeds, formatted image data for the image data feed is generated. The formatted image data represents one or more images received as part of the image data feed as formatted according to a predefined image format. In embodiments, the predefined image format is defined by a two-dimensional resolution that is specified by a pixel width and a pixel height, with the pixel width being a number of pixels in a horizontal direction and the pixel height being a number of pixels in a vertical direction orthogonal to the horizontal direction. The predefined image format may further be defined by a predefined color space, such as RGB (e.g., standard RGB (sRGB), Adobe™ RGB) or Hue, Saturation, Value/Brightness (HSV/HSB), for example.

Camera provisioning data, which also may be referred to as camera metadata, is obtained for each camera for the plurality of image data feeds received. The camera provisioning data is used to transform incoming image data from a native image format (i.e., the format output by the camera) to a standardized image format according to the predefined image format. The camera provisioning data includes, at least in embodiments, native resolution of the camera and color space of the camera. Other camera-specific information may be used as well, such as frame rate, white balance, exposure and dynamic range, gamma curve or log profile of the camera, lens characteristics (e.g., focal length, aperture), and/or bit depth. This information is stored in the data store 1810 as a result of a camera provisioning or onboarding process. This camera-specific information may be stored in its own database, partition, or table, such as in a provisioning camera document database. As the camera provisioning data is camera-specific, the camera provisioning data for a first image data feed is different than the camera provisioning data for a second image data feed, although the cameras for two or more other image data feeds may be the same, such as where the cameras are of the same model, for example. The method 1900 continues to step 1930.

In step 1930, the formatted image data is selectively provided to a plurality of asynchronous processing pipelines. As used herein, an asynchronous processing pipeline, when referred to in connection with processing image data, is a processing pipeline that is executed in an asynchronous manner such that processing of the image data is mutually exclusive from and is performable without reliance on another processing pipeline. Accordingly, an asynchronous processing pipeline operates independently from other processing pipelines, allowing it to process data without waiting for or being affected by processes of the processing pipeline. As used herein, a “processing pipeline” is a sequence of automated steps or stages implemented through software, where data, such as image data, is processed or transformed. Each asynchronous processing pipeline of the plurality of asynchronous processing pipelines is used to process the image data of one or more image data feeds of the plurality of image data feeds.

The formatted image data is selectively provided to the asynchronous processing pipelines through making the formatted image data available for consumption by said processing pipelines, such as through publishing the formatted image data using a publish-subscribe (often abbreviated as “pub-sub”) messaging subsystem, such pub-sub messaging subsystem 1822 discussed below. In general, the publish-subscribe messaging subsystem uses a publish-subscribe model or technique in which data is published and, once published, is distributed to subscribers subscribed to that published data. Such a subscription may be made on the basis of a topic or identifier that uniquely identifies a subset of published data from another subset of the published data. In embodiments, the asynchronous processing pipeline is configured to selectively access the published image data based on subscription data for the asynchronous processing pipeline.

In the embodiment depicted in FIG. 18, STOMP (Simple (or Streaming) Text Oriented Messaging Protocol) is used to publish the image data to the publish-subscribe messaging subsystem and is used to implement the pub-sub messaging subsystem 1822. In other embodiments, Advanced Message Queuing Protocol (AMQP) may be used to implement the pub-sub messaging subsystem 1822. According to embodiments, for implementing the publish-subscribe messaging subsystem 1822 using STOMP or AMQP, for example, an exchange on the messaging broker, which acts as a routing mechanism. Publishers send messages to this exchange without being aware of individual subscribers. Subscribers create queues and bind them to the exchange, specifying a routing key if needed. When a message with a matching routing key is published to the exchange, the broker ensures its delivery to the appropriate queues. Each subscriber then consumes messages from its own queue, ensuring that all subscribers receive their own copy of the message. This setup enables the decoupling of publishers from subscribers, allowing for scalable and flexible message dissemination. In other embodiments, other technologies may be used to implement the publish-subscribe messaging subsystem and/or to otherwise selectively provide the formatted image data to the asynchronous processing pipelines. The method 1900 ends.

With reference back to FIG. 18, the asynchronous containerized inference pipeline 1804 is implemented by the asynchronous containerized inference subsystem 1814 and is used to process the image data, particularly the formatted image data received from the message queue of the publish-subscribe messaging subsystem 1822. The asynchronous containerized inference pipeline 1804 is an example of an implementation of one of the plurality of asynchronous processing pipelines that are provided the formatted image data. The asynchronous containerized inference pipeline 1804 is an asynchronous processing pipeline that includes performing inference on image data in order to generate an output, which may be for a predefined purpose unique for each different asynchronous processing pipeline. Further, the asynchronous containerized inference pipeline 1804 is containerized, which means that the software embodying the processing pipeline is packaged as a stand-alone, executable software package that includes the application code, runtime (e.g., Python interpreter), system tools (e.g., command line tools), libraries, and settings, such as configuration files. In embodiments, Docker is used to containerize the software into a containerized package. This provides consistent functionality, isolation of instances, portability, and scalability through enabling efficient and relatively straightforward orchestration.

The asynchronous containerized inference subsystem 1814 includes a client module 1824 that operates to obtain appropriate image data to be processed by the asynchronous containerized inference pipeline 1804. The client module 1824 acts as a subscriber whereby the client module 1824 is provided image data that it has subscribed to. In embodiments, the subscription may be made on the basis of one or more selected cameras/image data feeds and/or according to image data selection criteria. The image data selection criteria specifies one or more conditions for image data that, when the one or more conditions are met by the image data, the image data is provided to the client 1824.

The one or more conditions may be predefined and may specify any of a variety of conditions, which may be tailored to the particular purpose or task of the particular asynchronous containerized inference pipeline. For example, according to one embodiment, the first asynchronous containerized inference pipeline 1804-1 is configured to perform a first task of occupant counting for a location, such as a building or an outdoor public park; the second asynchronous containerized inference pipeline 1804-2 is configured to perform a second task of detecting handheld weapons; and the third asynchronous containerized inference pipeline 1804-3 is configured to perform a third task of tracking individuals moving throughout a location. These different tasks may use different sets of image data. For example: for the first task, an image for each image data feed being monitored for occupant counts is selectively provided to the first asynchronous containerized inference pipeline 1804-1 at a predefined interval, such as every 1 second; for the second task, an image for each image data feed being monitored for handheld weapons is selectively provided to the second asynchronous containerized inference pipeline 1804-2 after an individual is detected and for every 2 seconds the individual remains in view; and, for the third task, an image for each image data feed being monitored for occupant counts is selectively provided to the third asynchronous containerized inference pipeline 1804-3 at a predefined interval (e.g., 0.5 seconds) that is different than the first interval.

With reference to FIG. 20, there is shown a method 2000 of asynchronously processing image data in real-time, which is performed by the asynchronous containerized inference pipeline 1804, according to the present embodiment.

The method 2000 begins with being selectively provided image data, or formatted image data, and this step 2010 may be performed through use of the method 1900, specifically steps 1910-1930. Step 1930 is used to selectively provide image data to the asynchronous containerized inference pipeline 1804. The method 2000 continues to step 2020.

In step 2020, a network graph for the image data feed being processed is obtained, where the network graph represents adjacency of zones within a location where the camera capturing the image data feed is located. The network graph may be the directed network graph 1600 (FIG. 16), for example. As shown in FIG. 18, a suitable or particular ML model is selected for inference and this selection may be made by selecting a ML model from a plurality of ML models that are trained for different purposes.

In step 2030, the network graph is used with the ML model for tracking detected objects through or within the location. In embodiments, parameters describing the network graph are obtained and used as input into the ML model for inference along with the image data of the image data feed. Various techniques may be used for tracking, such as learned object features obtained through contrastive learning, as discussed below. In embodiments, various tracking strategies may be used together in order to inform the training process. For example, SORT (Simple Online and Realtime Tracking) may be used along with a Kalman Filter (KF) in order to track objects within the image data feed. As appreciated based on the discussion herein, an image data feed with its multiple images taken at a constant time interval is a video or real-time video stream when received and processed in real-time. The SORT technique is an algorithm primarily used for multiple object tracking in video sequences (the image data feed with multiple sequential images). SORT provides a fast method to track detected objects in the image data feed, and may be used to predict future movement of said detected objects, such as when used in combination with the KF. In particular, while SORT and KF are used together to track objects and predict object movement, these techniques do not per se indicate image similarity. However, in embodiments, after applying object detection and then using SORT (with/without KF) to track these objects, the tracking data is used to provide insights into which frames or sequences are similar based on the objects present and their motion patterns. A tracking confidence may be provided along with each tracking prediction in order to inform the process how confident the tracking results are. This image data having similar/same objects being tracked may then be used to inform the ML model and/or may be used in parallel with the ML model in order to inform whether the output of the ML model is accurate and/or how to adjust said model during backpropagation used during training. The method 2000 continues to step 2040.

In step 2040, a determination is made as to whether a trigger is satisfied. The trigger is defined by a trigger condition and is satisfied when the trigger condition is true. The trigger condition is based on an output of the inference performed by the ML model and, more particularly, based on whether one or more detected objects meets predetermined criteria used as the trigger condition. In embodiments, the trigger condition is set based on whether an object is determined to disappear, as discussed above, for example. In other embodiments, other predetermine aspects of the inference output of the ML model may be evaluated and correlated to circumstances providing for learning opportunities. When the trigger is satisfied, associated ML model input, output, and/or other related data (such as the image data as processed at various stages of the asynchronous containerized inference pipeline 1804-o) are stored in the data store 1810 and used as input into the training pipeline 1806, which is discussed below. The method 2000 ends.

With reference back to FIG. 18, there is shown the training pipeline 1806, which is implemented by the training subsystem 1816. The training pipeline 1806 begins with receiving image data as a result of a trigger, which may be specified as one or more conditions, such as detecting disappearance of an individual or object. In such a case, for example, image data of the image data feed at or around (a predetermined amount of time before or after detection of) disappearance is input as triggered video input. The image data is then filtered based on image similarity so that image data of images with the most uniqueness are used for training as these provide higher training signals.

After the image data is filtered, an automatic annotation technique is performed, which may be implemented using a deep neural network. The deep neural network is configured to prioritize accuracy of annotation over latency relative to the neural network used for inference as a part of the asynchronous containerized inference pipeline 1804-o. This annotative ML model includes more parameters and/or layers, and may be trained using image data with high signals. After annotation or prior to annotation, the filtered image data is modified to remove a background layer so that focus is drawn to the foreground, which has the objects of interest. After annotation and background removal, one or more backgrounds are combined with the foreground (which is annotated). These modified images are then reviewed manually by a human for purposes of curating this image data for use in training. Training is then performed using this curated training data in order to improve the ML model used for inference in the asynchronous containerized inference pipeline 1804-o. This training is performed offline and, once complete, the trained ML model is stored in a model repository (such as at the data store 1810), which may then provide the model to the asynchronous containerized inference pipeline 1804-o for inference. In embodiments, contrastive training is used where, for example, the background-modified images for a given input image is used as a positive pair where such outputs are drawn together during training in an attempt to have the model learn important characteristics of the foreground regardless of the background. Of course, according to embodiments, other training techniques may be used in addition to or in lieu of this contrastive learning.

The analytics pipeline 1808 is implemented by the analytics subsystem 1818, which is used to serve up results or data (collectively, “result data”) based on results of the asynchronous containerized inference pipelines 1804-o. The analytics pipeline includes an application programming interface (API) that is used to provide the result data to individuals or systems, such as third party individuals or computer systems that are authorized access to the result data. The analytics pipeline 1808 may also include analyzing performance of one or more of the ML models used for inference as a part of the asynchronous containerized inference pipelines 1804-o. The analytics pipeline 1808 also includes a relational data store 1828 that is used to store result data from one or more of the asynchronous containerized inference pipelines 1804-o, such as a relational database.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. An image processing system, comprising:
at least one processor; and
memory accessible by the at least one processor, the memory storing computer instructions that, when executed by the at least one processor, cause the image processing system to:
receive an image data stream having image data captured by at least one camera;
identify spatial relationships between regions;
generate a directed network graph representing the identified spatial relationships; and
track movement of an entity between zones through use of the directed network graph.

2. The image processing system of claim 1, wherein the image processing system is configured to track movement of an entity between zones includes inspecting image data to determine whether the entity is in a particular zone.

3. The image processing system of claim 1, wherein zone configuration data is used to define the spatial relationships between the regions.

4. The image processing system of claim 3, wherein the zone configuration data is specified by a user through a graphical user interface (GUI).

5. The image processing system of claim 1, wherein the spatial relationships between the regions are learned by processing image data captured by a plurality of cameras having fields of views covering the regions.

6. The image processing system of claim 1, wherein the image processing system is configured to: obtain first image data and second image data, each of which represents an image depicting an individual; generate a first feature vector using the first image data and a second feature vector using the second image data; and determine whether the individual depicted in the first image data is the same individual depicted in the second image data through comparison of the first feature vector to the second feature vector.

7. The image processing system of claim 6, wherein the first feature vector and the second feature vector are generated using a machine learning (ML) technique, and wherein the ML technique is a neural network (NN).

8. The image processing system of claim 7, wherein the NN is a convolutional NN.

9. The image processing system of claim 7, wherein the first feature vector is a deep feature vector that is generated through ML processing of the first image data using more than one NN layer.

10. (canceled)

11. (canceled)

12. (canceled)

13. (canceled)

14. (canceled)

15. (canceled)

16. (canceled)

17. (canceled)

18. An image processing system, comprising:
at least one processor; and
memory accessible by the at least one processor, the memory storing computer instructions that, when executed by the at least one processor, cause the image processing system to:
receive an image data stream having image data captured by at least one camera;
identify spatial relationships between regions;
generate a directed network graph representing the identified spatial relationships; and
track movement of an entity between zones through use of the directed network graph.

19. The image processing system of claim 18, wherein the image processing system is configured to track movement of an entity between zones includes inspecting image data to determine whether the entity is in a particular zone.

20. The image processing system of claim 18, wherein zone configuration data is used to define the spatial relationships between the regions.

21. The image processing system of claim 20, wherein the zone configuration data is specified by a user through a graphical user interface (GUI).

22. The image processing system of claim 18, wherein the spatial relationships between the regions are learned by processing image data captured by a plurality of cameras having fields of views covering the regions.

23. The image processing system of claim 18, wherein the image processing system is configured to: obtain first image data and second image data, each of which represents an image depicting an individual; generate a first feature vector using the first image data and a second feature vector using the second image data; and determine whether the individual depicted in the first image data is the same individual depicted in the second image data through comparison of the first feature vector to the second feature vector.

24. The image processing system of claim 23, wherein the first feature vector and the second feature vector are generated using a machine learning (ML) technique, and wherein the ML technique is a neural network (NN).

25. The image processing system of claim 24, wherein the NN is a convolutional NN.

26. The image processing system of claim 24, wherein the first feature vector is a deep feature vector that is generated through ML processing of the first image data using more than one NN layer.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
